(19) United States
(12) Patent Application Publication
(10) Pub. No.: US 2026/0318498 A1
(43) Pub. Date: Oct. 15, 2026

(54) RENDERING LAMP

(71) Applicant: KOITO MANUFACTURING CO., LTD., Tokyo (JP)

(72) Inventor: Kentaro TANI, Shizuoka-shi, Shizuoka (JP)

(73) Assignee: KOITO MANUFACTURING CO., LTD., Tokyo (JP)

(21) Appl. No.: 19/478,632

(22) PCT Filed: Apr. 24, 2024
(86) PCT No.: PCT/JP2024/016153

§ 371 Date: Oct. 24, 2025

(30) Foreign Application Priority Data
Apr. 27, 2023 (JP) 2023-073057
May 8, 2023 (JP) 2023-076924

(51) Int. Cl. F21V 11/00; F21S 43/20; F21V 5/04

(52) U.S. Cl. CPC F21S 43/26411; B60Q 1/26; F21S 43/26231; B60Q 2400/50

(57) ABSTRACT

A rendering lamp fitting (10) is configured to shine emitted light from a light source unit (20) toward the front of the lamp fitting through a first opening portion (40a) to a third opening portion (40c) formed in a light shielding plate (40), and through a projection lens (30). The rendering lamp fitting (10) is disposed in a state in which the projection lens (30) is inclined downward with respect to a forward direction of the lamp fitting. A plate-shaped portion (32) extending in a direction inclined downward with respect to the forward direction of the lamp is formed in an upper region of an outer peripheral edge portion of the projection lens (30).

### TECHNICAL FIELD

The present disclosure relates to a rendering lamp that forms a rendering light distribution pattern.

### BACKGROUND ART

In the related art, there has been known a rendering lamp for forming a rendering light distribution pattern that is a light distribution pattern for rendering characters, symbols, and the like on a road surface in front of the lamp. The rendering lamp is configured to emit emission light from a light emitting element toward a front of the lamp via a projection lens.

“Patent Literature 1” discloses an in-vehicle rendering lamp mounted on a vehicle in a state in which a projection lens is inclined downward with respect to a front direction of the lamp.

In the rendering lamp described in “Patent Literature 1”, a light shielding plate that shields a part of light traveling from a light emitting element toward the projection lens is disposed between the light emitting element and the projection lens. The rendering lamp described in “Patent Literature 1” is configured such that emission light from the light emitting element is incident on the projection lens via an opening formed in the light shielding plate, and the emission light from the projection lens forms a rendering light distribution pattern.

Further, “Patent Literature 2” discloses a rendering lamp in which a condenser lens is disposed between a light emitting element and a light shielding plate.

### CITATION LIST

### Patent Literature

Patent Literature 1: JP2022-60067A
Patent Literature 2: WO2021/140932

### SUMMARY OF INVENTION

### Technical Problem

By the emission light from the in-vehicle rendering lamp forming the rendering light distribution pattern, it is possible to express the intention of a subject vehicle to the surroundings when the vehicle is traveling at night. Accordingly, it is possible to call attention to other vehicles, pedestrians, and the like.

However, it may not be preferred that the projection lens appears to be emitting light when the rendering lamp is turned on. For example, when the rendering lamp is turned on in synchronization with turning on of a front turn signal lamp or a backup lamp, not only the front turn signal lamp or the backup lamp appears to being emitting light at an original mounting position, but also the projection lens of the rendering lamp appears to be emitting light at another position. Therefore, this may cause discomfort to other vehicles, pedestrians, and the like.

In addition, as in the rendering lamp described in “Patent Literature 2”, if the condenser lens is disposed between the light emitting element and the light shielding plate, the emission light from the light emitting element can be efficiently incident on the projection lens.

However, even when such a condenser lens is provided as the rendering lamp, it is necessary to dispose the rendering lamp obliquely downward in order to form the rendering light distribution pattern on the road surface in front of the lamp. Therefore, a structure for mounting the rendering lamp to a vehicle body or the like tends to be complicated.

These problems may also occur in a rendering lamp other than the in-vehicle rendering lamp.

A first object of the present disclosure is to provide a rendering lamp that can form a rendering light distribution pattern, which is less likely to cause discomfort to the surroundings.

A second object of the present disclosure is to provide a rendering lamp that can be easily mounted on a vehicle body or the like and can efficiently form a rendering light distribution pattern.

### Solution to Problem

A rendering lamp according to an aspect of the present disclosure is a rendering lamp configured to form a rendering light distribution pattern by emitting emission light from a light emitting element toward a front of the rendering lamp via a projection lens, in which
a light shielding plate configured to shield a part of the light traveling from the light emitting element toward the projection lens is disposed between the light emitting element and the projection lens,
the light shielding plate is formed with an opening for causing the emission light from the light emitting element to be incident on the projection lens,
the projection lens is disposed in a state inclined downward with respect to a front direction of the lamp, and
a plate-shaped portion is formed in an upper region of an outer peripheral edge portion of the projection lens, the plate-shaped portion extending in a direction inclined downward with respect to the front direction of the lamp.

A rendering lamp according to another aspect of the present disclosure is a rendering lamp configured to form a rendering light distribution pattern by emitting emission light from a light emitting element toward a front of the rendering lamp via a projection lens, in which
a light shielding plate configured to shield a part of the light traveling from the light emitting element toward the projection lens is disposed between the light emitting element and the projection lens,
the light shielding plate is formed with an opening for causing the emission light from the light emitting element to be incident on the projection lens,
a condenser lens configured to condense the emission light from the light emitting element toward the opening is disposed between the light emitting element and the light shielding plate,
the projection lens is disposed in a state of being inclined downward with respect to a front direction of the lamp, and
the light shielding plate is disposed in a state of being inclined forward with respect to the condenser lens.

### Advantageous Effects of Invention

In the rendering lamp according to one aspect of the present disclosure, the light shielding plate is formed with the opening for causing the emission light from the light emitting element to be incident on the projection lens, and the projection lens is disposed in a state of being inclined downward with respect to the front direction of the lamp. Therefore, it is possible to easily form a rendering light distribution pattern having a desired shape on the road surface in front of the lamp.

The plate-shaped portion is formed in the upper region of the outer peripheral edge portion of the projection lens, the plate-shaped portion extending in the direction inclined downward with respect to the front direction of the lamp. Therefore, it is possible to effectively prevent the projection lens itself from appearing to be emitting light when the rendering lamp is turned on. Accordingly, when the rendering lamp is turned on, it is possible to prevent other vehicles, pedestrians, and the like from feeling useless discomfort.

In this way, according to the present disclosure, the rendering lamp, which forms a rendering light distribution pattern, can easily form a rendering light distribution pattern that is less likely to cause discomfort to the surroundings.

In the rendering lamp according to another aspect of the present disclosure, the projection lens is disposed with an optical axis thereof inclined downward with respect to the front direction of the lamp. Therefore, it is possible to easily form the rendering light distribution pattern on the road surface in front of the lamp. In addition, the light shielding plate is disposed in a state of being inclined forward with respect to the condenser lens, and thus the opening formed in the light shielding plate can be easily disposed in an appropriate direction with respect to the projection lens. Accordingly, even when the condenser lens is disposed in a state of being directed to the front direction of the lamp or the like, the emission light from the light emitting element can be efficiently incident on the projection lens. Therefore, the rendering lamp can be easily mounted on the vehicle body or the like, and can efficiently form the rendering light distribution pattern.

According to the present disclosure, the rendering lamp that forms the rendering light distribution pattern can be easily mounted on the vehicle body or the like, and can efficiently form the rendering light distribution pattern.

### BRIEF DESCRIPTION OF DRAWINGS

FIG. 1 is a front view illustrating a rendering lamp according to a first embodiment of the present disclosure.

FIG. 2 illustrates optical paths of light emitted from light emitting elements in a cross-sectional view taken along a line II-II in FIG. 1.

FIG. 3 illustrates optical paths of light emitted from the light emitting element located at a center in an up-down direction in the cross-sectional view taken along the line II-II in FIG. 1.

FIG. 4 is a cross-sectional view taken along a line IV-IV in FIG. 2.

FIG. 5 is an exploded front view of main components of the rendering lamp.

FIG. 6 is an exploded perspective view of the main components.

FIG. 7 is a side view illustrating a state in which the rendering lamp are mounted on a vehicle.

FIG. 8 is a plan view illustrating a state in which the rendering lamp are mounted on the vehicle.

FIG. 9 is a cross-sectional view illustrating a first modification of the first embodiment. FIG. 10 is a cross-sectional view illustrating a second modification of the first embodiment.

FIG. 11 is a front view illustrating a third modification of the first embodiment.

FIG. 12 is a front view illustrating a rendering lamp according to a second embodiment of the present disclosure.

FIG. 13 illustrates optical paths of light emitted from light emitting elements in a cross-sectional view taken along a line XIII-XIII in FIG. 12.

FIG. 14 illustrates optical paths of light emitted from the light emitting element located at a center in an up-down direction in the cross-sectional view taken along the line XIII-XIII in FIG. 12.

FIG. 15 is a cross-sectional view taken along a line XV-XV in FIG. 13.

FIG. 16 is an exploded front view of main components of the rendering lamp.

FIG. 17 is an exploded perspective view of the main components.

FIG. 18 is a side view illustrating a state in which the rendering lamp are mounted on a vehicle.

FIG. 19 is a plan view illustrating a state in which the rendering lamp are mounted on the vehicle.

FIG. 20 is a front view illustrating a modification of the second embodiment.

FIG. 21 is a plan view illustrating a state in which rendering lamp are mounted on a vehicle according to the modification of the second embodiment.

### DESCRIPTION OF EMBODIMENTS

Hereinafter, embodiments of the present disclosure will be described with reference to the drawings.

### First Embodiment

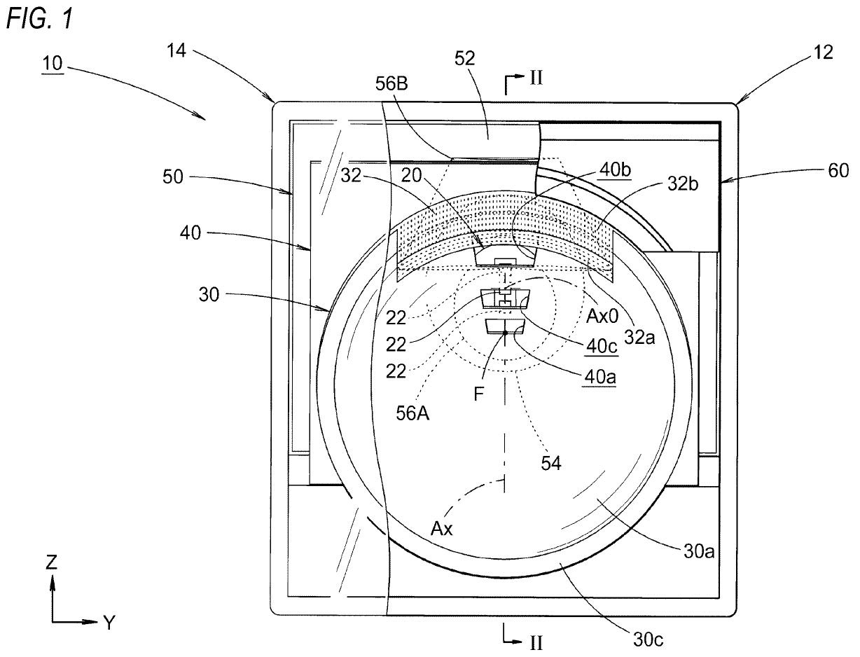

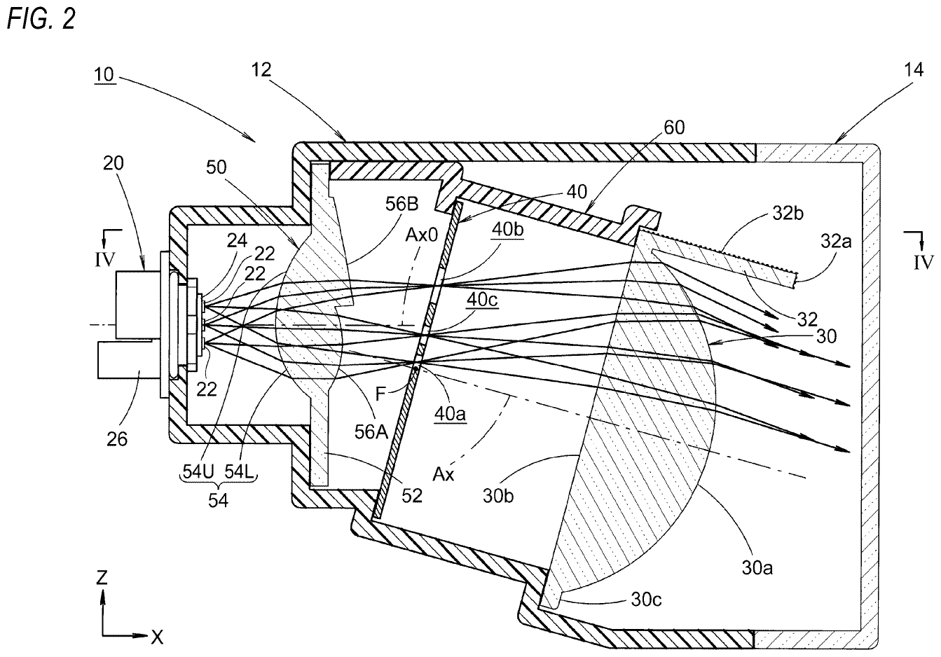

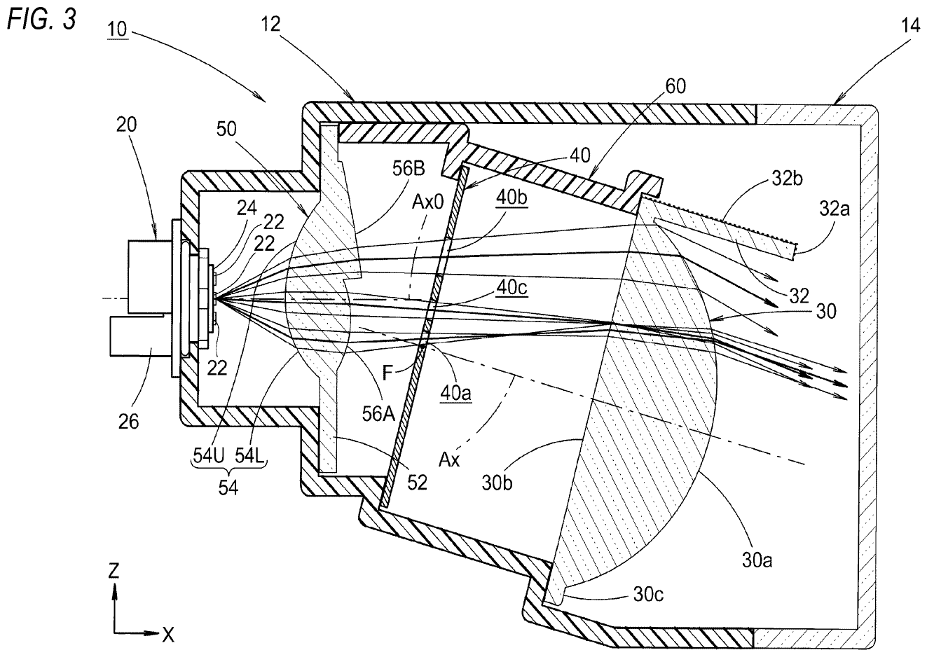

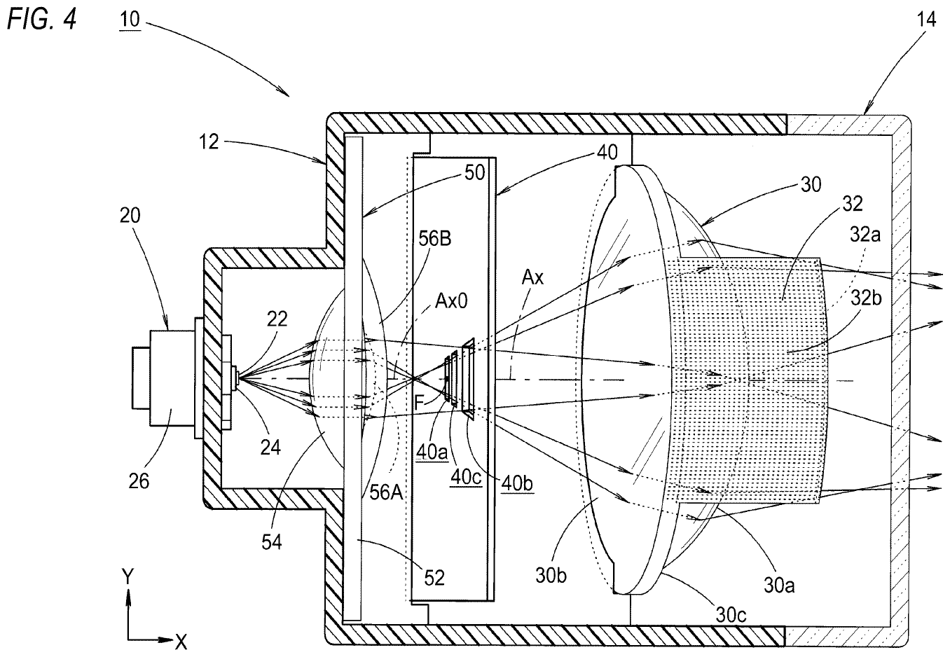

FIG. 1 is a front view illustrating a rendering lamp 10 according to a first embodiment of the present disclosure. In addition, FIG. 2 illustrates optical paths of light emitted from light emitting elements 22 in a cross-sectional view taken along a line II-II in FIG. 1. FIG. 3 illustrates optical paths of light emitted from the light emitting element 22 located at a center in an up-down direction in the cross-sectional view taken along the line II-II in FIG. 1. FIG. 4 is a cross-sectional view taken along a line IV-IV in FIG. 2.

FIG. 2 illustrates the optical paths in a case in which the emission light from the three light emitting elements 22 passes through center positions of the first opening 40a to the third opening 40c. In addition, FIG. 3 illustrates the optical paths in a case in which the emission light from the central light emitting element 22 passes through the center positions and both upper and lower end positions of the first opening 40a to the third opening 40c. Further, FIG. 4 illustrates the optical paths in a case in which the emission light from the three light emitting elements 22 passes through both left and right end positions of the first opening 40a to the third opening 40c.

In FIGS. 1 and 4, a direction indicated by X is a “front of a lamp” (or “rear” of a vehicle). A direction indicated by Y is a “left direction” (“right direction” in a front view of the lamp, and “right direction” of the vehicle) orthogonal to the “front of the lamp” . A direction indicated by Z is an “upward direction”. The same applies to figures other than FIGS. 1 to 4.

Before describing a specific configuration of the rendering lamp 10 according to the first embodiment, an outline thereof will be described.

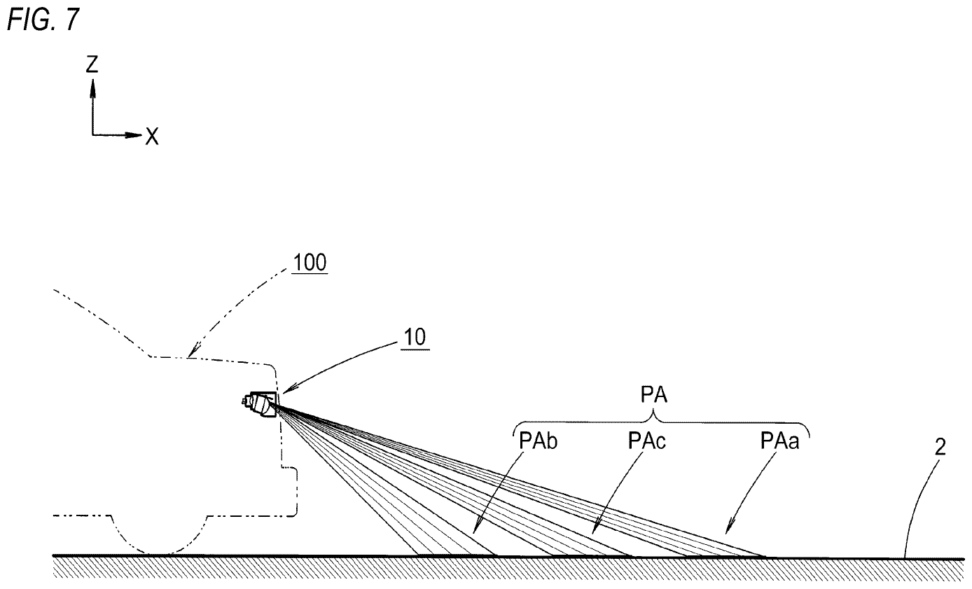

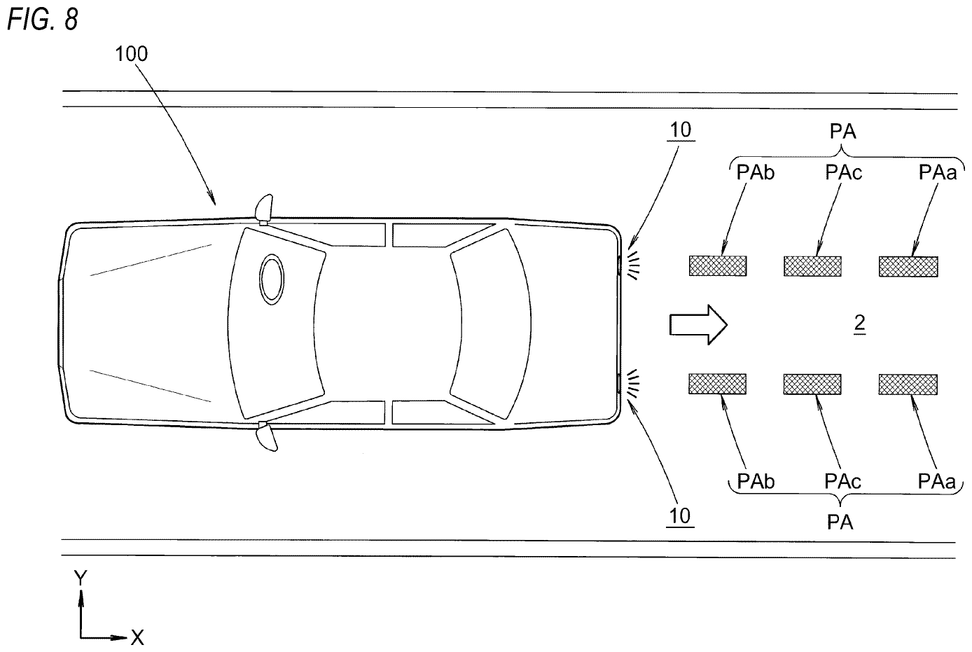

FIG. 7 is a side view illustrating a state in which the rendering lamp 10 are mounted on a vehicle 100. FIG. 8 is a plan view illustrating a state in which the rendering lamp 10 are mounted on the vehicle 100.

As illustrated in FIGS. 7 and 8, the rendering lamp 10 emit light obliquely downward toward a rear of the vehicle in a state of being mounted at two positions at an interval in a vehicle width direction at rear end portions of the vehicle 100. The pair of left and right rendering lamp 10 are turned on in synchronization with turning on of backup lamps (not illustrated).

The pair of left and right rendering lamp 10 have the same configuration. Rendering light distribution patterns PA each including three rendering light distribution patterns PAa, PAb, and PAc are formed on a road surface 2 in front of the lamp (that is, a road surface in rear of the vehicle) by the emission light from the pair of left and right rendering lamp 10. The details of the rendering light distribution pattern PA will be described later.

Next, a specific configuration of the rendering lamp 10 will be described.

As illustrated in FIGS. 1 to 4, the rendering lamp 10 has a configuration in which a part of a light source unit 20, a projection lens 30, a light shielding plate 40, a condenser lens 50, and a bracket 60 are incorporated within a lamp chamber formed by a lamp body 12 and a plain-glass translucent cover 14 that is mounted on a front end opening of the lamp body 12. The rendering lamp 10 forms the rendering light distribution pattern PA by emitting the emission light from the light source unit 20 toward the front of the lamp via the projection lens 30.

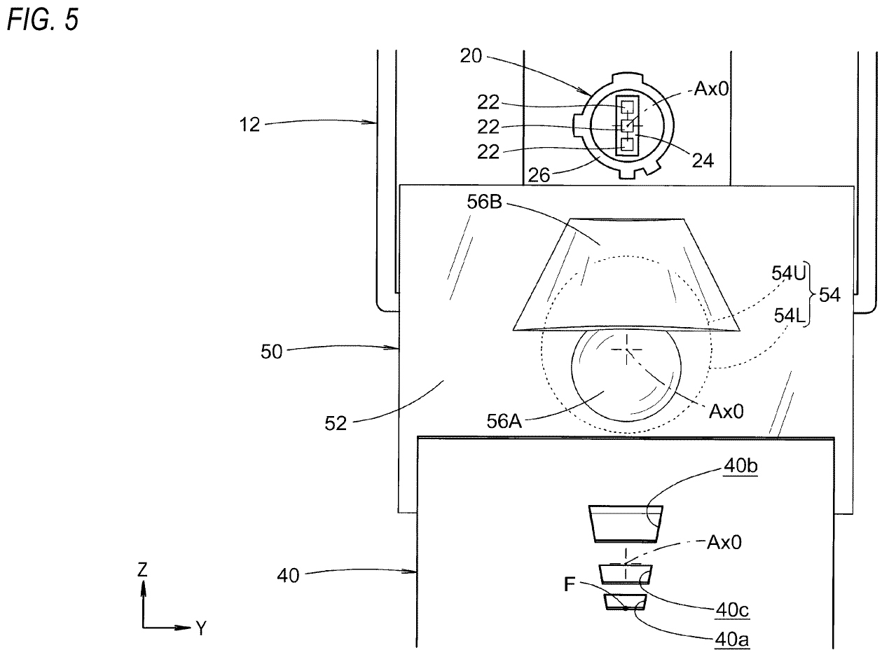

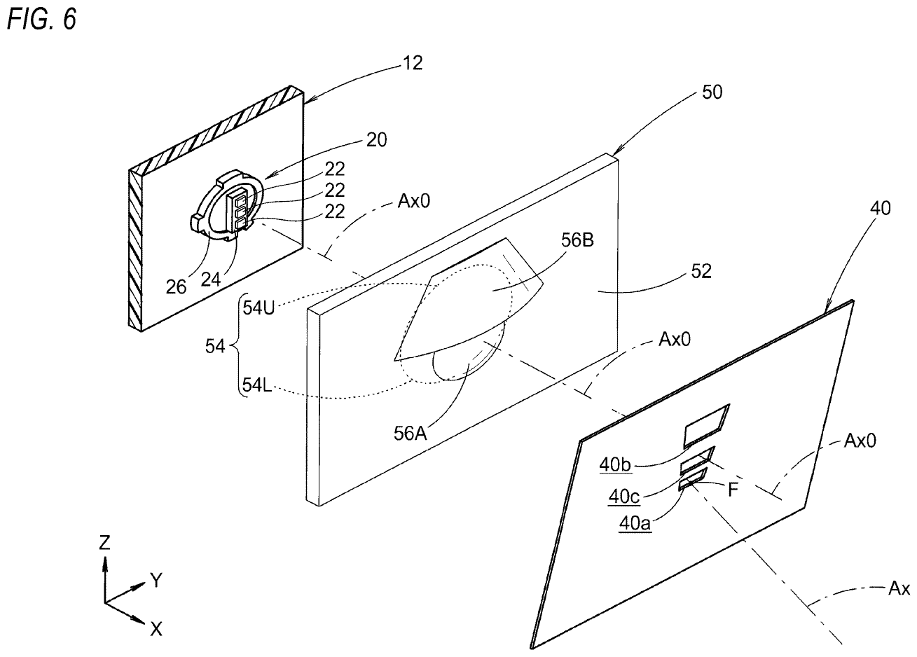

FIG. 5 is an exploded front view of main components of the rendering lamp 10. FIG. 6 is an exploded perspective view of the main components of the rendering lamp 10.

As illustrated in FIGS. 5 and 6, the light source unit 20 includes three light emitting elements 22. The three light emitting elements 22 are detachably supported by the lamp body 12. The three light emitting elements 22 are all white light emitting diodes each having the same size of square light emitting surface. The three light emitting elements 22 are mounted on a common substrate 24 in a state of being arranged at equal intervals in the up-down direction. The substrate 24 is supported by a plug 26.

The light source unit 20 is mounted on a rear wall portion of the lamp body 12 at the plug 26. Accordingly, the three light emitting elements 22 are arranged in a state of facing the front direction of the lamp in the lamp chamber.

In FIGS. 1 to 6, a reference axis Ax0 extending in a front-rear direction of the lamp so as to pass through a light emitting center of the light emitting element 22 located at the center is indicated by a one-dot chain line.

As illustrated in FIGS. 1 to 4, the projection lens 30 is a flat convex lens in which a front surface 30a is a convex curved surface and a rear surface 30b is a flat surface. An annular flange portion 30c is formed on an outer peripheral edge portion of the front surface 30a of the projection lens 30.

The projection lens 30 is disposed in a state of being inclined downward with respect to the front direction of the lamp. Specifically, the projection lens 30 is disposed such that an optical axis Ax thereof extends in a direction inclined downward by about 10° to 20° (for example, about 13.5°) with respect to the front direction of the lamp (that is, with respect to the reference axis Ax0). A rear focal point F of the projection lens 30 is located immediately below the reference axis Ax0. The projection lens 30 is supported by the lamp body 12 in a lower region thereof and is supported by the bracket 60 in an upper region thereof.

The projection lens 30 of the present embodiment is configured such that a plate-shaped portion 32 extending in a direction inclined downward with respect to the front direction of the lamp is integrally formed in an upper region of the annular flange portion 30c.

The plate-shaped portion 32 extends in a circumferential direction along the annular flange portion 30c, and extends to the front of the lamp beyond the front surface 30a of the projection lens 30. The plate-shaped portion 32 is formed such that a cross-sectional shape including the optical axis Ax of the projection lens 30 has a linear shape extending substantially parallel to the optical axis Ax (specifically, in a direction slightly away from the optical axis Ax toward the front of the lamp). A front end surface 32a and an outer peripheral surface 32b of the plate-shaped portion 32 are subjected to a light diffusion treatment (or a light diffusion treatment such as forming a plurality of diffusing lens elements) such as frost processing or texturing.

The light shielding plate 40 is disposed between the light source unit 20 and the projection lens 30. The light shielding plate 40 shields a part of the light traveling from the light source unit 20 toward the projection lens 30. The light shielding plate 40 is implemented as a flat plate-shaped member having a rectangular outer shape close to a square in the front view of the lamp. The light shielding plate 40 is disposed in a state of being inclined forward with respect to a vertical plane perpendicular to the reference axis Ax0. Specifically, the light shielding plate 40 is disposed such that a forward inclination angle thereof is the same value as a forward inclination angle of the projection lens 30, and the light shielding plate 40 extends along a rear focal plane of the projection lens 30.

The light shielding plate 40 is supported by the lamp body 12 in a lower region thereof and is supported by the bracket 60 in an upper region thereof.

The light shielding plate 40 is formed with the first opening 40a, the second opening 40b, and the third opening 40c as three openings for causing the emission light from the light source unit 20 to be incident on the projection lens 30.

The first opening 40a is an opening for long-distance rendering and is formed at a position close to the rear focal point F of the projection lens 30. Specifically, the first opening 40a has an inverted isosceles trapezoidal opening shape. The first opening 40a is formed such that the rear focal point F of the projection lens 30 is located at a center of a lower end surface thereof in a left-right direction.

The second opening 40b is an opening for short-distance rendering, and is formed at a position above the first opening 40a. Specifically, the second opening 40b is formed at a position above the reference axis Ax0, and has an inverted isosceles trapezoidal opening shape that is larger than that of the first opening 40a. The second opening 40b is formed such that both side end surfaces thereof are located on extension lines of both side end surfaces of the first opening 40a.

The third opening 40c is an opening for middle-distance rendering, and is disposed between the first opening 40a and the second opening 40b at a position slightly closer to the first opening 40a than the second opening 40b. Specifically, the third opening 40c is formed such that an upper end surface thereof is located at substantially the same position as the reference axis Ax0 in the up-down direction. In this case, the third opening 40c has an inverted isosceles trapezoidal opening shape that is larger than that of the first opening 40a but smaller than that of the second opening 40b, and is formed such that both side end surfaces thereof are located on the extension lines of both side end surfaces of the first opening 40a.

The condenser lens 50 is disposed between the light source unit 20 and the light shielding plate 40. The condenser lens 50 condenses the emission light from the light source unit 20 toward the first opening 40a to the third opening 40c.

Specifically, the condenser lens 50 includes a plate-shaped portion 52 extending along the vertical plane orthogonal to the reference axis Ax0, a convex lens portion 54 formed on a rear surface of the plate-shaped portion 52, and a first lens portion 56A and a second lens portion 56B formed on a front surface of the plate-shaped portion 52.

The first lens portion 56A emits incident light from a lower region 54L of the convex lens portion 54 toward the first opening 40a and the third opening 40c. Specifically, the first lens portion 56A is formed in a convex curved surface shape with a uniform circumference. Accordingly, the first lens portion 56A condenses the incident light from the lower region 54L of the convex lens portion 54 toward the first opening 40a and the third opening 40c.

The second lens portion 56B emits incident light from an upper region 54U of the convex lens portion 54 toward the second opening 40b. Specifically, the second lens portion 56B has a convex curved vertical cross-sectional shape close to a straight line inclined backward with respect to the vertical plane orthogonal to the reference axis Ax0. Accordingly, the second lens portion 56B deflects the incident light from the upper region 54U of the convex lens portion 54 downward toward the second opening 40b. The second lens portion 56B is formed such that a horizontal cross-sectional shape thereof is a uniform convex curve shape on the left and right. Accordingly, the second lens portion 56B slightly condenses the incident light from the upper region 54U of the convex lens portion 54 in a direction closer to the reference axis Ax0 in a horizontal direction.

The first lens portion 56A has a circular outer shape in the front view of the lamp. On the other hand, the second lens portion 56B has an isosceles trapezoidal outer shape in the front view of the lamp. A lower end edge of the second lens portion 56B intersects an upper end portion of the first lens portion 56A and extends in the horizontal direction.

A boundary position between the lower region 54L and the upper region 54U of the convex lens portion 54 is set to an intermediate position between the reference axis Ax0 and the lower end edge of the second lens portion 56B.

In addition, a curvature of the convex lens portion 54 in the vertical direction is set to a smaller value in the upper region 54U than in the lower region 54L. Accordingly, the convex lens portion 54 is formed such that the emission light from the light source unit 20 is incident on the lower region 54L as light traveling in a direction closer to the horizontal direction than the upper region 54U.

On the other hand, the convex lens portion 54 has a uniform convex curved cross-sectional shape on the left and right in the horizontal direction. Accordingly, the convex lens portion 54 causes the emission light from the light source unit 20 to be incident as light substantially parallel to the reference axis Ax0.

The condenser lens 50 is supported by the lamp body 12 at the plate-shaped portion 52.

The bracket 60 supports upper regions of the projection lens 30 and the light shielding plate 40. The bracket 60 is supported by the lamp body 12 in a state of abutting against an upper region of the plate-shaped portion 52 of the condenser lens 50 from the front side of the lamp.

Next, the rendering light distribution pattern PA illustrated in FIGS. 7 and 8 will be described.

The three rendering light distribution patterns PAa to PAc constituting the rendering light distribution pattern PA are all substantially rectangular light distribution patterns that are long in the front-rear direction of the lamp. The three rendering light distribution patterns PAa to PAc are formed in substantially the same size, and are formed in a long distance area, a short distance area, and a middle distance area of the road surface 2 in front of the lamp at substantially equal intervals in a series arrangement.

The rendering light distribution pattern PAa formed in a long distance area is a light distribution pattern formed by emitting the emission light from the light source unit 20 toward the front of the lamp via the condenser lens 50, the first opening 40a of the light shielding plate 40, and the projection lens 30. The emission light from the light source unit 20 is emission light from the three light emitting elements.

The rendering light distribution pattern PAa is formed as a reverse projection image of the first opening 40a having an inverted isosceles trapezoidal opening shape formed in the light shielding plate 40.

The first opening 40a is located at a lowermost position among the three openings, that is, the first opening 40a to the third opening 40c. Therefore, the rendering light distribution pattern PAa is formed in a long distance area of the road surface 2 in front of the lamp. Specifically, the first opening 40a is formed such that the center of the lower end surface thereof in the left-right direction is located at the rear focal point F of the projection lens 30. Therefore, the emission light from the projection lens 30 is emitted toward the front of the lamp as substantially parallel light slightly downward from the optical axis Ax. Accordingly, the rendering light distribution pattern PAa is formed as a substantially rectangular light distribution pattern at a position substantially corresponding to a downward inclination angle of the projection lens 30.

Of the emission light from the light source unit 20, the light incident on the projection lens 30 via the first opening 40a is convergent light that is incident from the lower region 54L of the convex lens portion 54 of the condenser lens 50 and is emitted from the first lens portion 56A. Therefore, the rendering light distribution pattern PAa is formed in a long distance area of the road surface 2 in front of the lamp, but is formed as a light distribution pattern having sufficient sharpness and brightness.

The rendering light distribution pattern PAb formed in a short distance area is a light distribution pattern formed by emitting the emission light from the light source unit 20 toward the front of the lamp via the condenser lens 50, the second opening 40b of the light shielding plate 40, and the projection lens 30.

The rendering light distribution pattern PAb is formed as a reverse projection image of the second opening 40b having an inverted isosceles trapezoidal opening shape formed in the light shielding plate 40.

The second opening 40b is located at an uppermost position among the three openings, that is, the first opening 40a to the third opening 40c. Therefore, the rendering light distribution pattern PAb is formed in a short distance area of the road surface 2 in front of the lamp. Specifically, the second opening 40b has an opening shape larger than that of the first opening 40a. Therefore, the rendering light distribution pattern PAb is formed in a short distance area, but the rendering light distribution pattern PAb is formed as a substantially rectangular light distribution pattern having substantially the same size as the rendering light distribution pattern PAa.

Of the emission light from the light source unit 20, the light incident on the projection lens 30 via the second opening 40b is light that is incident from the upper region 54U of the convex lens portion 54 of the condenser lens 50 and is emitted from the second lens portion 56B. Therefore, the rendering light distribution pattern PAb is formed in a short distance area of the road surface 2 in front of the lamp, but is formed as a light distribution pattern having substantially the same sharpness and brightness as the rendering light distribution pattern PAa.

The rendering light distribution pattern PAc formed in a middle distance area is a light distribution pattern formed by emitting the emission light from the light source unit 20 toward the front of the lamp via the condenser lens 50, the third opening 40c of the light shielding plate 40, and the projection lens 30.

The rendering light distribution pattern PAc is formed as a reverse projection image of the third opening 40c having an inverted isosceles trapezoidal opening shape formed in the light shielding plate 40.

The third opening 40c is located between the first opening 40a and the second opening 40b. Therefore, the rendering light distribution pattern PAc is formed in a middle distance area of the road surface 2 in front of the lamp. Specifically, the third opening 40c has an opening shape larger than that of the first opening 40a and smaller than that of the second opening 40b. Therefore, the rendering light distribution pattern PAc is formed in a middle distance area, but the rendering light distribution pattern PAc is formed as a substantially rectangular light distribution pattern having substantially the same size as the rendering light distribution patterns PAa and PAb.

Of the emission light from the light source unit 20, the light incident on the projection lens 30 via the third opening 40c is convergent light that is incident from the lower region 54L of the convex lens portion 54 of the condenser lens 50 and is emitted from the first lens portion 56A. The third opening 40c is located on the front side of the lamp with respect to the first opening 40a, and thus the brightness of the light incident on the projection lens 30 via the third opening 40c is reduced accordingly. Therefore, the rendering light distribution pattern PAc is formed in a middle distance area, but is formed as a light distribution pattern having substantially the same sharpness and brightness as the rendering light distribution pattern PAa formed in a long distance area.

In FIGS. 2 to 4, when the emission light from the light source unit 20 passes through the first opening 40a to the third opening 40c, a part of the emission light may reach the projection lens 30 as uncontrolled light due to being reflected by inner peripheral surfaces of the first opening 40a to the third opening 40c. It is conceivable that the uncontrolled light is emitted toward the front of the lamp as stray light. If the stray light is emitted as upward light toward the front of the lamp, when the rendering lamp 10 is observed from the front of the lamp (that is, from the rear of the vehicle), the upper region of the projection lens 30 may appear to be emitting light.

However, the plate-shaped portion 32 is formed in the upper region of the annular flange portion 30c of the projection lens 30, the plate-shaped portion 32 extending in the direction inclined downward with respect to the front direction of the lamp. The front end surface 32a and the outer peripheral surface 32b of the plate-shaped portion 32 are subjected to a light diffusion treatment. Therefore, the stray light emitted upward from the projection lens 30 is blocked or reduced by the plate-shaped portion 32, and thus the projection lens 30 itself is effectively prevented from emitting light from the front of the lamp when the rendering lamp 10 is turned on.

Next, operations of the present embodiment will be described.

The rendering lamp 10 according to the present embodiment forms the rendering light distribution pattern PA by emitting the emission light from the light source unit 20 (that is, the emission light from the three light emitting elements 22) toward the front of the lamp via the first opening 40a to the third opening 40c formed in the light shielding plate 40, and the projection lens 30. The projection lens 30 is disposed in a state of being inclined downward with respect to the front direction of the lamp. The plate-shaped portion 32 is formed in an upper region of the outer peripheral edge portion of the projection lens 30, the plate-shaped portion 32 extending in the direction inclined downward with respect to the front direction of the lamp. Therefore, the following operations and effects can be obtained.

In the rendering lamp 10 according to the present embodiment, the light shielding plate 40 is formed with the first opening 40a to the third opening 40c for causing the emission light from the light source unit 20 to be incident on the projection lens 30. In addition, the projection lens 30 is disposed in a state of being inclined downward with respect to the front direction of the lamp. Therefore, it is possible to easily form the rendering light distribution pattern PA having a desired shape on the road surface in front of the lamp.

Further, the plate-shaped portion 32 is formed in the upper region of the outer peripheral edge portion of the projection lens 30, the plate-shaped portion 32 extending in the direction inclined downward with respect to the front direction of the lamp. Therefore, it is possible to effectively prevent the projection lens 30 itself from appearing to be emitting light when the rendering lamp 10 is turned on. Accordingly, it is possible to provide the rendering lamp 10 that is less likely to cause useless discomfort to other vehicles, pedestrians, and the like when the rendering lamp 10 is turned on.

According to the present embodiment, the rendering lamp 10, which forms the rendering light distribution pattern PA, can easily form the rendering light distribution pattern PA that is less likely to cause discomfort to the surroundings.

The projection lens 30 of the present embodiment has a configuration in which a surface (specifically, the front end surface 32a and the outer peripheral surface 32b) of the plate-shaped portion 32 is subjected to a light diffusion treatment. Therefore, it is possible to more effectively prevent the projection lens 30 itself from appearing to be emitting light when the rendering lamp 10 is turned on.

In addition, the annular flange portion 30c is formed on the outer peripheral edge portion of the projection lens 30 of the present embodiment. The plate-shaped portion 32 extends in the circumferential direction along the annular flange portion 30c. Therefore, it is possible to more effectively prevent the projection lens 30 itself from appearing to be emitting light when the rendering lamp 10 is turned on while sufficiently maintaining the ease of molding the projection lens 30.

In the rendering lamp 10 according to the present embodiment, the light shielding plate 40 is disposed in a state inclined forward with respect to the vertical plane. Therefore, the first opening 40a to the third opening 40c can be easily arranged in an appropriate direction with respect to the projection lens 30. Accordingly, the emission light from the light source unit 20 can be efficiently incident on the projection lens 30. Therefore, it is possible to easily form the rendering light distribution pattern PA as a clear and bright light distribution pattern.

In the first embodiment, the description has been given assuming that the plate-shaped portion 32 of the projection lens 30 has a cross-sectional shape including the optical axis Ax that is formed into a linear shape, but the cross-sectional shape may be formed into another shape. For example, the plate-shaped portion 32 of the projection lens 30 may have a cross-sectional shape including the optical axis Ax that is formed into a curved shape, a polygonal line shape, or the like.

In the first embodiment, the annular flange portion 30c is formed on the outer peripheral edge portion of the projection lens 30. The description has been given assuming that the plate-shaped portion 32 extends from the annular flange portion 30c, but the plate-shaped portion 32 may extend directly from the outer peripheral edge portion of the front surface 30a of the projection lens 30.

In the first embodiment, the description has been given assuming that the front end surface 32a and the outer peripheral surface 32b of the plate-shaped portion 32 of the projection lens 30 is subjected to a light diffusion treatment, but a configuration in which only the front end surface 32a or the outer peripheral surface 32b is subjected to a light diffusion treatment, or a configuration in which no light diffusion treatment is applied at all, may also be employed. In this case, the projection lens 30 is also formed with the plate-shaped portion 32, whereby the projection lens 30 itself is prevented from appearing to being emitting light to a certain extent when the rendering lamp 10 is turned on.

In the first embodiment, the description has been given assuming that the light source unit 20 includes the three light emitting elements 22, but the light source unit 20 may include two or less light emitting elements 22 or four or more light emitting elements 22. In addition, the light emitting element 22 may not be incorporated in the light source unit 20.

In the first embodiment, the description has been given assuming that light-emitting colors of the three light emitting elements 22 are white, but other light-emitting colors (for example, blue or green) may be adopted.

In the first embodiment, the description has been given assuming that the rendering lamp 10 emits light obliquely downward toward the rear of the vehicle in a state of being mounted at the rear end portion of the vehicle 100, but the rendering lamp 10 may also be mounted at the front end portion of the vehicle 100. In this case, the rendering lamp 10 may emit light obliquely downward toward the front of the vehicle.

In the first embodiment, the description has been given assuming that the rendering light distribution pattern PA is formed on the road surface 2 in front of the lamp by the emission light from the rendering lamp 10, but a rendering light distribution pattern may be formed on a wall surface disposed in front of the lamp, a wall surface extending toward the front of the lamp, or the like.

Next, a modification of the first embodiment will be described.

First, a first modification of the first embodiment will be described.

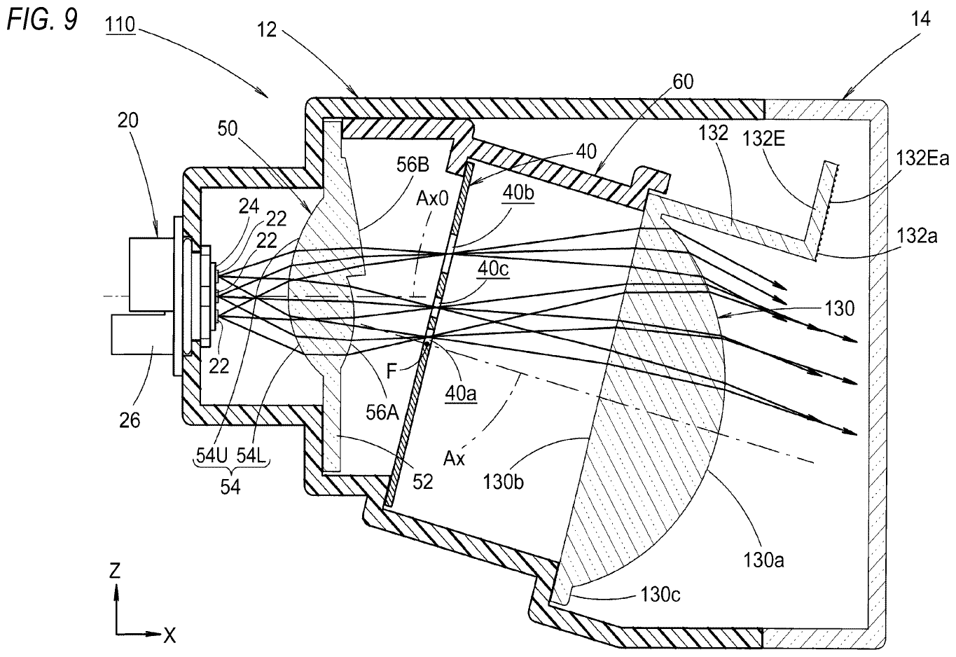

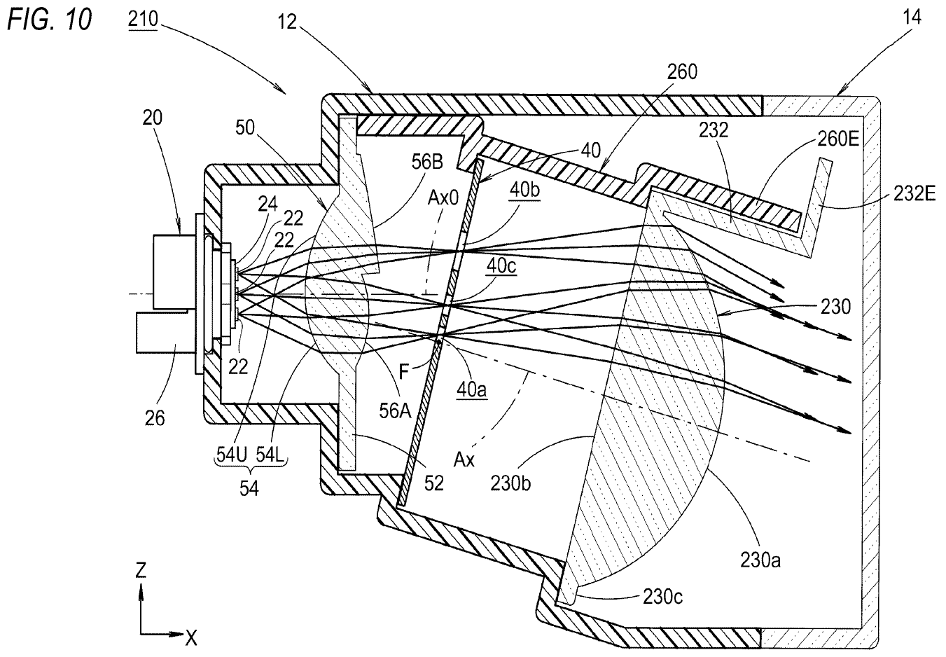

FIG. 9 is a cross-sectional view illustrating a rendering lamp 110 according to the first modification. FIG. 9 is a cross-sectional view similar to FIG. 2.

As illustrated in FIG. 9, a basic configuration of the rendering lamp 110 according to the first modification is similar to that of the first embodiment, but a configuration of a projection lens 130 is partially different from that of the projection lens 30 of the first embodiment.

Similar to the projection lens 30 according to the first embodiment, the projection lens 130 according to the present modification is a flat convex lens in which a front surface 130a is a convex curved surface and a rear surface 130b is a flat surface. An annular flange portion 130c is formed on an outer peripheral edge portion of the front surface 130a of the projection lens 130. Further, a plate-shaped portion 132 is integrally formed in an upper region of the annular flange portion 130c, the plate-shaped portion 132 extending in a direction inclined downward with respect to the front direction of the lamp.

In addition, the projection lens 130 of the present modification is formed with a plate-shaped extension portion 132E extending upward at a front end portion of the plate-shaped portion 132. The plate-shaped extension portion 132E extends by a substantially constant length along a plane substantially orthogonal to the optical axis Ax of the projection lens 130.

In the projection lens 130 of the present modification, a front end surface 132a of the plate-shaped portion 132 and a front surface 132Ea of the plate-shaped extension portion 132E are subjected to a light diffusion treatment. That is, in the projection lens 130 of the present modification, the front surface 132Ea of the plate-shaped extension portion 132E is subjected to a light diffusion treatment instead of the outer peripheral surface 32b of the plate-shaped portion 32 in the projection lens 30 of the first embodiment.

In the rendering lamp 110 according to the present modification, the plate-shaped portion 132 is formed in an upper region of an outer peripheral edge portion of the projection lens 130, the plate-shaped portion 132 extending in the direction inclined downward with respect to the front direction of the lamp. The plate-shaped extension portion 132E extending upward is formed at the front end portion of the plate-shaped portion 132. Therefore, it is possible to effectively prevent the projection lens 130 itself from appearing to be emitting light when the rendering lamp 110 is turned on.

The front end surface 132a of the plate-shaped portion 132 and the front surface 132Ea of the plate-shaped extension portion 132E of the projection lens 130 are subjected to a light diffusion treatment. Therefore, it is possible to more effectively prevent the projection lens 130 itself from appearing to be emitting light when the rendering lamp 110 is turned on.

Next, a second modification of the first embodiment will be described.

FIG. 10 is a cross-sectional view illustrating a rendering lamp 210 according to the second modification. FIG. 10 is a cross-sectional view similar to FIG. 2.

As illustrated in FIG. 10, a basic configuration of the rendering lamp 210 according to the present modification is similar to that of the first embodiment, but a configuration of a projection lens 230 is partially different from that of the first embodiment. Accordingly, a configuration of a bracket 260 according to the second modification is partially different from that of the first embodiment.

Similar to the projection lens 30 according to the first embodiment, the projection lens 230 according to the present modification is a flat convex lens in which a front surface 230a is a convex curved surface and a rear surface 230b is a flat surface. An annular flange portion 230c is formed on an outer peripheral edge portion of the front surface 230a. A plate-shaped portion 232 is integrally formed in an upper region of the annular flange portion 230c, the plate-shaped portion 232 extending in a direction inclined downward with respect to the front direction of the lamp.

Similar to the projection lens 130 of the first modification, in the projection lens 230 of the present modification, a plate-shaped extension portion 232E extending upward is formed at a front end portion of the plate-shaped portion 232. Similar to the plate-shaped extension portion 132E of the first modification, the plate-shaped extension portion 232E extends by a substantially constant length along a plane substantially orthogonal to the optical axis Ax of the projection lens 230.

In the projection lens 230 of the present modification, unlike the projection lens 130 of the first modification, the front end surface 132a of the plate-shaped portion 132 and the front surface 132Ea of the plate-shaped extension portion 132E are not subjected to a light diffusion treatment.

On the other hand, in the present modification, the projection lens 230 is supported by the bracket 260 in an upper region thereof. However, the bracket 260 of the present modification includes an extension cover portion 260E with which the plate-shaped portion 232 of the projection lens 230 is covered. The extension cover portion 260E extends in a circumferential direction along an outer peripheral surface of the plate-shaped portion 232. A front end surface of the extension cover portion 260E is located near a rear surface of the plate-shaped extension portion 232E.

In the rendering lamp 210 according to the present modification, the plate-shaped portion 232 is formed in an upper region of an outer peripheral edge portion of the projection lens 230, the plate-shaped portion 232 extending in the direction inclined downward with respect to the front direction of the lamp. The plate-shaped extension portion 232E extending upward is formed at the front end portion of the plate-shaped portion 232. Therefore, it is possible to effectively prevent the projection lens 230 itself from appearing to be emitting light when the rendering lamp 210 is turned on.

In the projection lens 230, the plate-shaped portion 232 is covered with the extension cover portion 260E of the bracket 260. Therefore, it is possible to more effectively prevent the projection lens 230 itself from appearing to be emitting light when the rendering lamp 210 is turned on.

In addition, the projection lens 230 is formed with the plate-shaped extension portion 232E extending upward at the front end portion of the plate-shaped portion 232. Therefore, the extension cover portion 260E of the bracket 260 is prevented from being directly visible from the front of the lamp.

Next, a third modification of the first embodiment will be described.

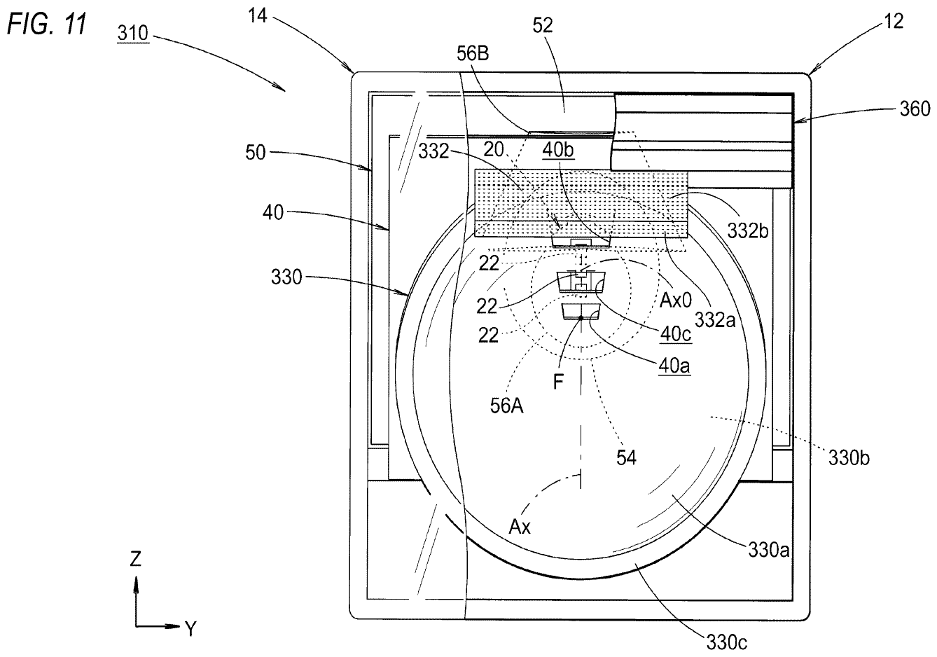

FIG. 11 is a front view illustrating a rendering lamp 310 according to the third modification. FIG. 11 is a view from the same direction as in FIG. 1.

As illustrated in FIG. 11, a basic configuration of the rendering lamp 310 according to the present modification is similar to that of the first embodiment, but a configuration of a projection lens 330 is partially different from that of the first embodiment. Accordingly, a configuration of a bracket 360 is partially different from that of the first embodiment.

Similar to the projection lens 30 according to the first embodiment, the projection lens 330 according to the present modification is a flat convex lens in which a front surface 330a is a convex curved surface and a rear surface 330b is a flat surface. An annular flange portion 330c is formed on an outer peripheral edge portion of the front surface 330a. A plate-shaped portion 332 is integrally formed in an upper region of the annular flange portion 330c, the plate-shaped portion 332 extending in a direction inclined downward with respect to the front direction of the lamp.

The plate-shaped portion 332 of the present modification does not extend in the circumferential direction along the annular flange portion 330c, but extends in a flat plate shape in the horizontal direction while maintaining a vertical cross-sectional shape including the optical axis Ax. In the present modification, the projection lens 330 is supported by the bracket 360 in an upper region thereof, but the bracket 360 extends in the horizontal direction along a rear surface of the annular flange portion 330c.

On the other hand, similar to the projection lens 30 of the first embodiment, in the projection lens 330 of the present modification, a front end surface 332a and an outer peripheral surface 332b of the plate-shaped portion 332 are subjected to a light diffusion treatment.

In the rendering lamp 310 according to the present modification, the plate-shaped portion 332 is formed in an upper region of an outer peripheral edge portion of the projection lens 330, the plate-shaped portion 332 extending in the direction inclined downward with respect to the front direction of the lamp. Therefore, it is possible to effectively prevent the projection lens 330 itself from appearing to be emitting light when the rendering lamp 310 is turned on.

In the projection lens 330, the front end surface 332a and the outer peripheral surface 332b of the plate-shaped portion 332 are subjected to a light diffusion treatment. Therefore, it is possible to more effectively prevent the projection lens 330 itself from appearing to be emitting light when the rendering lamp 310 is turned on.

Numerical values shown as specifications in the first embodiment and the first modification to the third modification are merely examples, and as a matter of course, these numerical values may be set to different values as appropriate.

In addition, the present disclosure is not limited to the configurations described in the first embodiment and the first modification to the third modification, and a configuration added with various other changes may be adopted.

### Second Embodiment

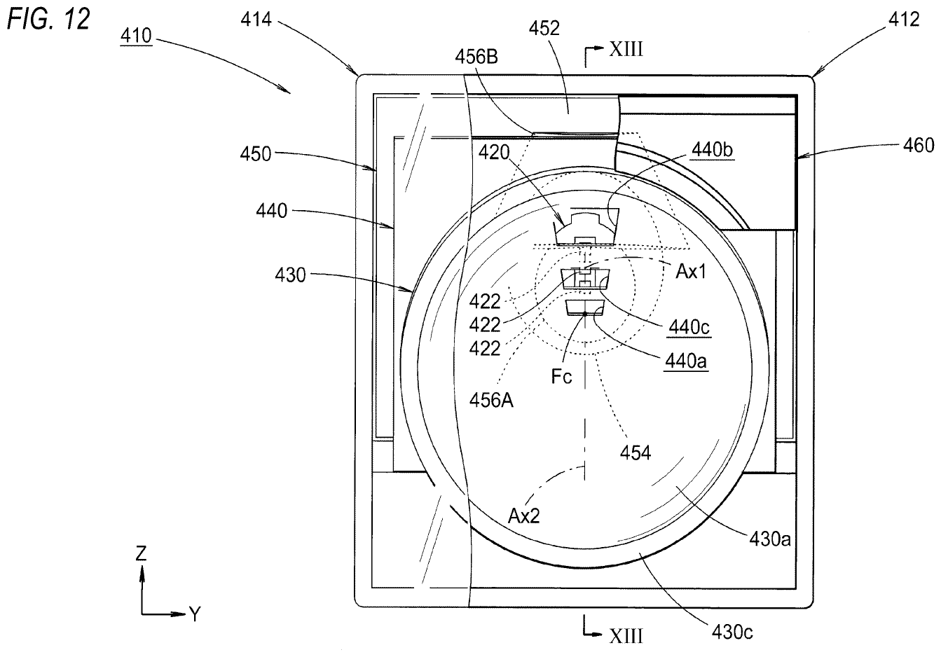

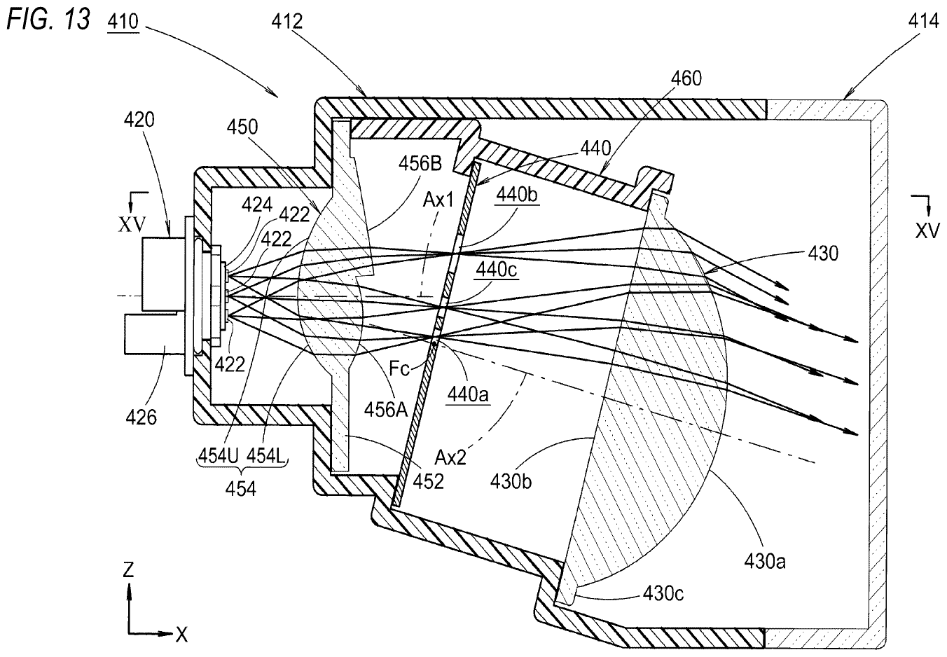

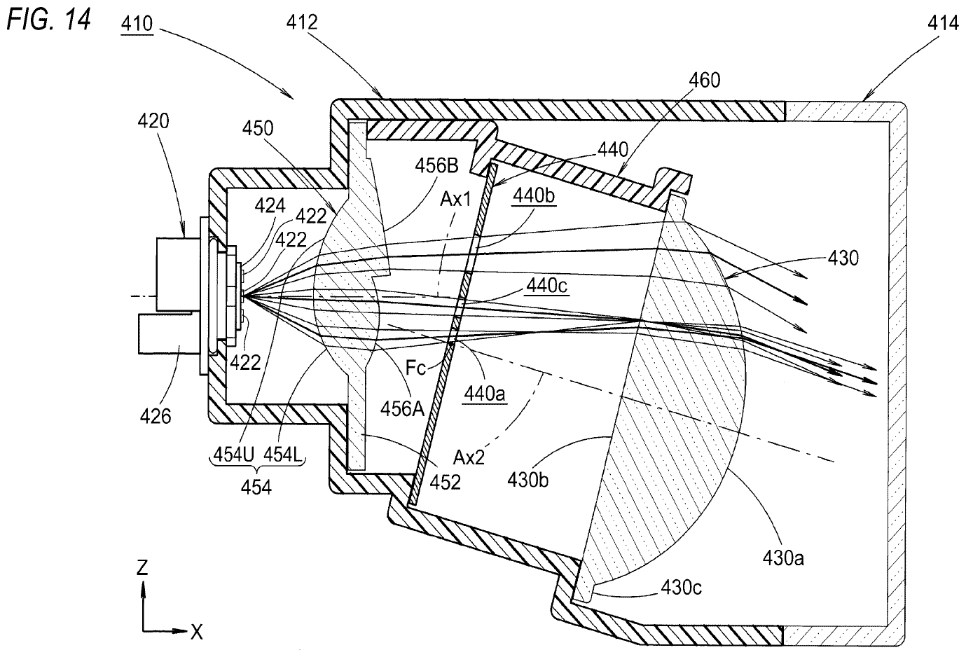

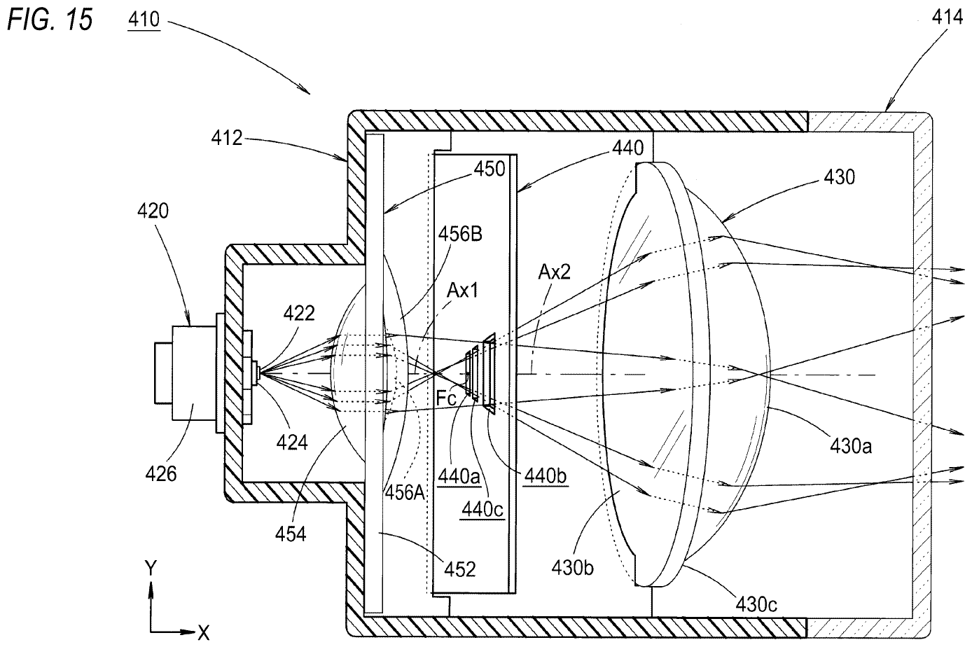

FIG. 12 is a front view illustrating the rendering lamp 10 according to an embodiment of the present disclosure. In addition, FIG. 13 illustrates optical paths of light emitted from light emitting elements 422 in a cross-sectional view taken along a line XIII-XIII in FIG. 12. FIG. 14 illustrates optical paths of light emitted from the light emitting element 422 located at a center in the up-down direction in the cross-sectional view taken along the line XIII-XIII in FIG. 12. FIG. 15 is a cross-sectional view taken along a line XV-XV in FIG. 13.

FIG. 13 illustrates the optical paths in a case in which the emission light from the three light emitting elements 422 passes through center positions of the first opening 440a to the third opening 440c. In addition, FIG. 14 illustrates the optical paths in a case in which the emission light from the central light emitting element 422 passes through the center positions and both upper and lower end positions of the first opening 440a to the third opening 440c. Further, FIG. 15 illustrates the optical paths in a case in which the emission light from the three light emitting elements 422 passes through both left and right end positions of the first opening 440a to the third opening 440c.

Before describing a specific configuration of a rendering lamp 410 according to the second embodiment, an outline thereof will be described.

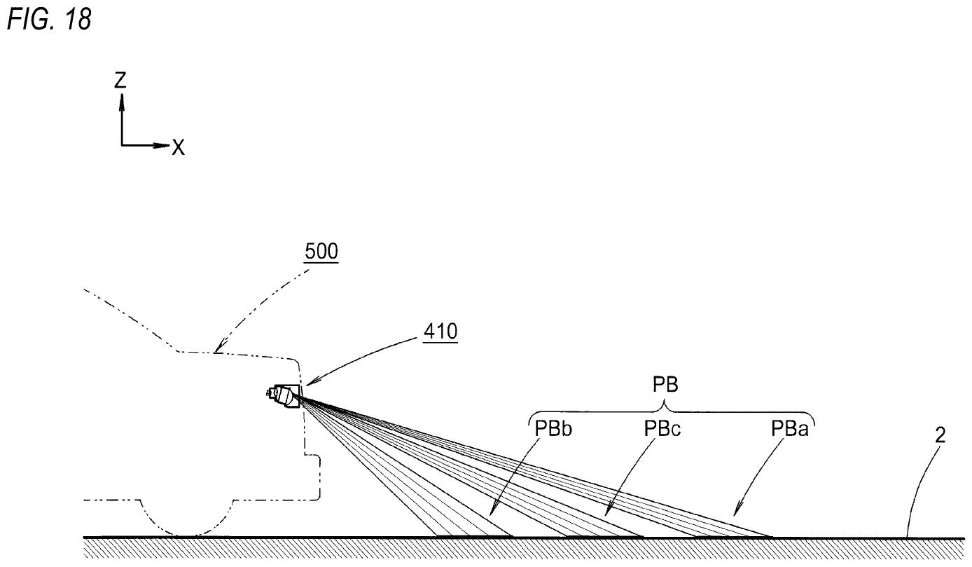

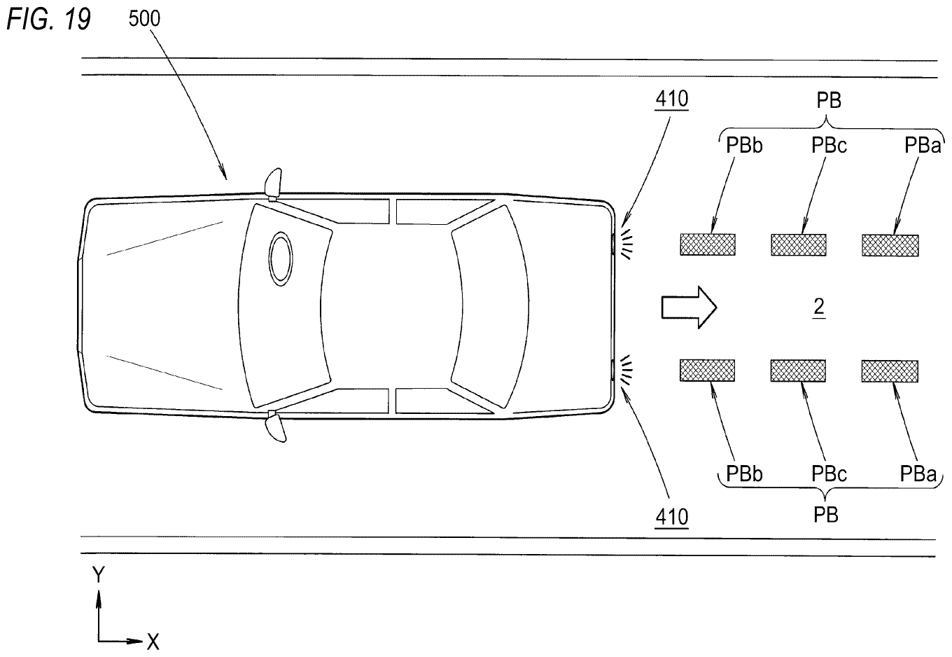

FIG. 18 is a side view illustrating a state in which the rendering lamp 410 are mounted on a vehicle 500. FIG. 19 is a plan view illustrating a state in which the rendering lamp 410 are mounted on the vehicle 500.

As illustrated in FIGS. 18 and 19, the rendering lamp 410 emit light obliquely downward toward the rear of the vehicle in a state of being mounted at two positions at an interval in a vehicle width direction at rear end portions of the vehicle 500. The pair of left and right rendering lamp 410 are turned on in synchronization with turning on of backup lamps (not illustrated).

The pair of left and right rendering lamp 410 have the same configuration. Rendering light distribution patterns PB each including three rendering light distribution patterns PBa, PBb, and PBc are formed on the road surface 2 in front of the lamp (that is, a road surface in rear of the vehicle) by the emission light from the pair of left and right rendering lamp 410. The details of the rendering light distribution pattern PB will be described later.

Next, a specific configuration of the rendering lamp 410 will be described.

As illustrated in FIGS. 12 to 15, the rendering lamp 410 has a configuration in which a part of a light source unit 420, a projection lens 430, a light shielding plate 440, a condenser lens 450, and a bracket 460 are incorporated within a lamp chamber formed by a lamp body 412 and a plain-glass translucent cover 414 that is mounted on a front end opening of the lamp body 412. The rendering lamp 410 forms a rendering light distribution pattern PB by emitting the emission light from the light source unit 420 toward the front of the lamp via the projection lens 430.

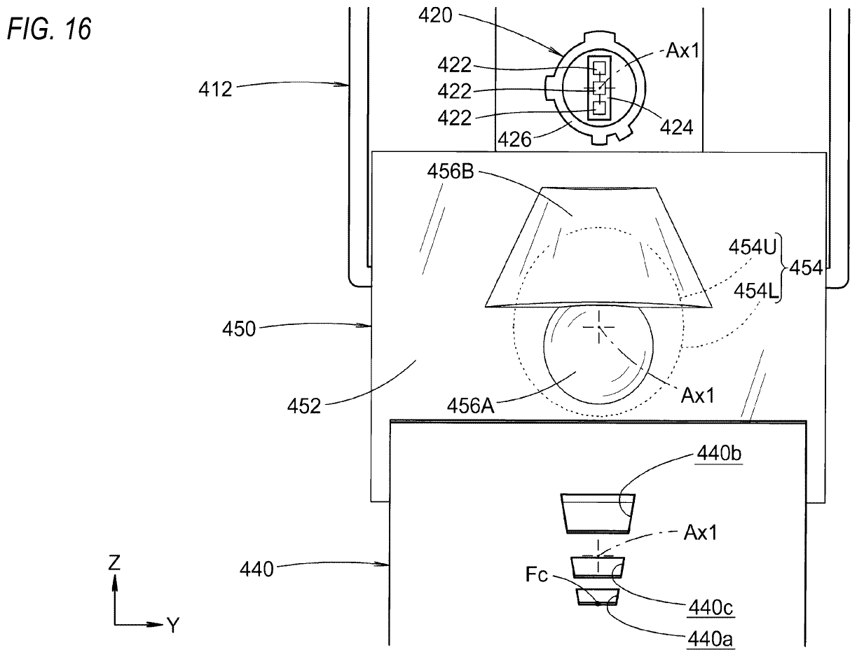

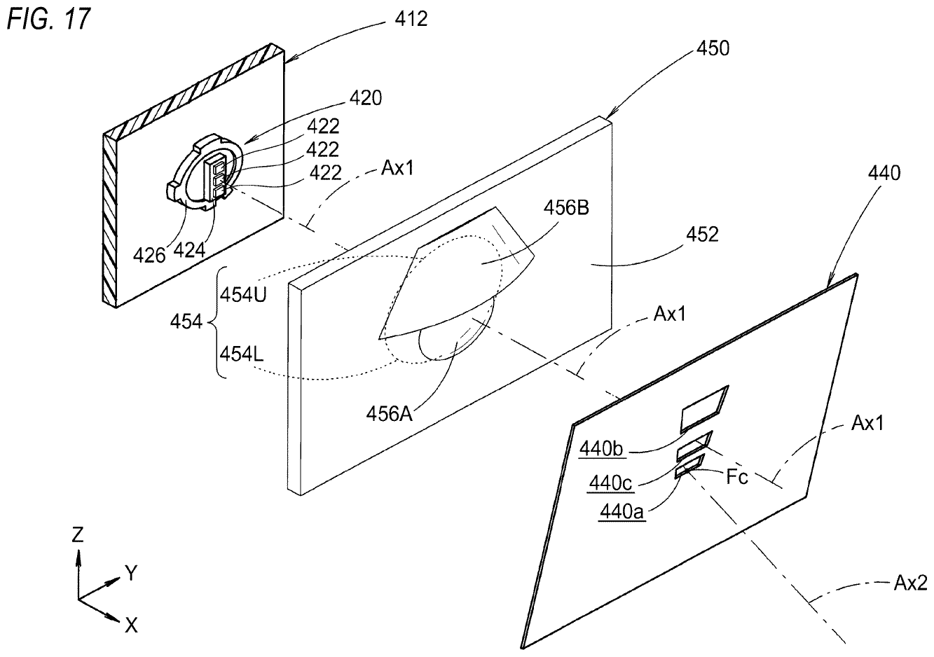

FIG. 16 is an exploded front view of main components of the rendering lamp 410. FIG. 17 is an exploded perspective view of the main components.

As illustrated in FIGS. 16 and 17, the light source unit 420 includes the three light emitting elements 422. The three light emitting elements 422 are detachably supported by the lamp body 412. The three light emitting elements 422 are all white light emitting diodes each having the same size of square light emitting surface, and are mounted on a common substrate 424 in a state of being arranged at equal intervals in the up-down direction. The substrate 424 is supported by a plug 426.

The light source unit 420 is mounted on a rear wall portion of the lamp body 412 at the plug 426. Accordingly, the three light emitting elements 422 are arranged in a state of facing the front direction of the lamp in the lamp chamber.

In FIGS. 12 to 17, a reference axis Ax1 extending in a front-rear direction of the lamp so as to pass through a light emitting center of the light emitting element 422 located at the center is indicated by a one-dot chain line.

As illustrated in FIGS. 12 to 15, the projection lens 430 is a flat convex lens in which a front surface 430a is a convex curved surface and a rear surface 430b is a flat surface. An annular flange portion 430c is formed on an outer peripheral edge portion of the front surface 430a of the projection lens 430.

The projection lens 430 is disposed in a state of being inclined downward with respect to the front direction of the lamp. Specifically, the projection lens 430 is disposed such that an optical axis Ax2 thereof extends in a direction inclined downward by about 10° to 20° (for example, about 13.5°) with respect to the front direction of the lamp (that is, with respect to the reference axis Ax1). A rear focal point Fc of the projection lens 430 is located immediately below the reference axis Ax1. The projection lens 430 is supported by the lamp body 412 in a lower region thereof and is supported by the bracket 460 in an upper region thereof.

The light shielding plate 440 is disposed between the light source unit 420 and the projection lens 430. The light shielding plate 440 shields a part of the light traveling from the light source unit 420 toward the projection lens 430. The light shielding plate 440 is implemented as a flat plate-shaped member having a rectangular outer shape close to a square in the front view of the lamp. The light shielding plate 440 is disposed in a state of being inclined forward with respect to a vertical plane perpendicular to the reference axis Ax1. Specifically, the light shielding plate 440 is disposed such that a forward inclination angle thereof is the same value as a forward inclination angle of the projection lens 430, and the light shielding plate 440 extends along a rear focal plane of the projection lens 430.

The light shielding plate 440 is supported by the lamp body 412 in a lower region thereof and is supported by the bracket 460 in an upper region thereof.

The light shielding plate 440 is formed with the first opening 440a, the second opening 440b, and the third opening 440c as three openings for causing the emission light from the light source unit 420 to be incident on the projection lens 430.

The first opening 440a is an opening for long-distance rendering and is formed at a position close to the rear focal point Fc of the projection lens 430. Specifically, the first opening 440a has an inverted isosceles trapezoidal opening shape. The first opening 440a is formed such that the rear focal point Fc of the projection lens 430 is located at a center of a lower end surface thereof in the left-right direction.

The second opening 440b is an opening for short-distance rendering, and is formed at a position above the first opening 440a. Specifically, the second opening 440b is formed at a position above the reference axis Ax1, and has an inverted isosceles trapezoidal opening shape that is larger than that of the first opening 440a. The second opening 440b is formed such that both side end surfaces thereof are located on extension lines of both side end surfaces of the first opening 440a.

The third opening 440c is an opening for middle-distance rendering, and is disposed between the first opening 440a and the second opening 440b at a position slightly closer to the first opening 440a than the second opening 440b. Specifically, the third opening 440c is formed such that an upper end surface thereof is located at substantially the same position as the reference axis Ax1 in the up-down direction. The third opening 440c has an inverted isosceles trapezoidal opening shape that is larger than that of the first opening 440a but smaller than that of the second opening 440b, and is formed such that both side end surfaces thereof are located on the extension lines of both side end surfaces of the first opening 440a.

The condenser lens 450 is disposed between the light source unit 420 and the light shielding plate 440. The condenser lens 450 condenses the emission light from the light source unit 420 toward the first opening 440a to the third opening 440c.

Specifically, the condenser lens 450 includes a plate-shaped portion 452 extending along the vertical plane orthogonal to the reference axis Ax1, a convex lens portion 454 formed on a rear surface of the plate-shaped portion 452, and a first lens portion 456A and a second lens portion 456B formed on a front surface of the plate-shaped portion 452.

The first lens portion 456A emits incident light from a lower region 454L of the convex lens portion 454 toward the first opening 440a and the third opening 440c. Specifically, the first lens portion 456A is formed in a convex curved surface shape with a uniform circumference. Accordingly, the first lens portion 456A condenses the incident light from the lower region 454L of the convex lens portion 454 toward the first opening 440a and the third opening 440c.

The second lens portion 456B emits incident light from an upper region 454U of the convex lens portion 454 toward the second opening 440b. Specifically, the second lens portion 456B has a convex curved vertical cross-sectional shape close to a straight line inclined backward with respect to the vertical plane orthogonal to the reference axis Ax1. Accordingly, the second lens portion 456B deflects the incident light from the upper region 454U of the convex lens portion 454 downward toward the second opening 440b. The second lens portion 456B is formed such that a horizontal cross-sectional shape thereof is a uniform convex curve shape on the left and right. Accordingly, the second lens portion 456B slightly condenses the incident light from the upper region 454U of the convex lens portion 454 in a direction closer to the reference axis Ax1 in the horizontal direction.

The first lens portion 456A has a circular outer shape in the front view of the lamp. On the other hand, the second lens portion 456B has an isosceles trapezoidal outer shape in the front view of the lamp. A lower end edge of the second lens portion 456B intersects an upper end portion of the first lens portion 456A and extends in the horizontal direction.

A boundary position between the lower region 454L and the upper region 454U of the convex lens portion 454 is set to an intermediate position between the reference axis Ax1 and the lower end edge of the second lens portion 456B.

In addition, a curvature of the convex lens portion 454 in the vertical direction is set to a smaller value in the upper region 454U than in the lower region 454L. Accordingly, the convex lens portion 454 is formed such that the emission light from the light source unit 420 is incident on the lower region 454L as light traveling in a direction closer to the horizontal direction than the upper region 454U.

On the other hand, the convex lens portion 454 has a uniform convex curved cross-sectional shape on the left and right in the horizontal direction. Accordingly, the convex lens portion 454 causes the emission light from the light source unit 420 to be incident as light substantially parallel to the reference axis Ax1.

The condenser lens 450 is supported by the lamp body 412 at the plate-shaped portion 452.

The bracket 460 supports upper regions of the projection lens 430 and the light shielding plate 440. The bracket 460 is supported by the lamp body 412 in a state of abutting against an upper region of the plate-shaped portion 452 of the condenser lens 450 from the front side of the lamp.

Next, the rendering light distribution pattern PB illustrated in FIGS. 18 and 19 will be described.

The three rendering light distribution patterns PBa to PBc constituting the rendering light distribution pattern PB are all substantially rectangular light distribution patterns that are long in the front-rear direction of the lamp. The three rendering light distribution patterns PBa to PBc are formed in substantially the same size, and are formed in a long distance area, a short distance area, and a middle distance area of the road surface 2 in front of the lamp at substantially equal intervals in a series arrangement.

The rendering light distribution pattern PBa formed in a long distance area is a light distribution pattern formed by emitting the emission light from the light source unit 420 toward the front of the lamp via the condenser lens 450, the first opening 440a of the light shielding plate 440, and the projection lens 430. The emission light from the light source unit 420 is emission light from the three light emitting elements.

The rendering light distribution pattern PBa is formed as a reverse projection image of the first opening 440a having an inverted isosceles trapezoidal opening shape formed in the light shielding plate 440.

The first opening 440a is located at a lowermost position among the three openings, that is, the first opening 440a to the third opening 440c. Therefore, the rendering light distribution pattern PBa is formed in a long distance area of the road surface 2 in front of the lamp. Specifically, the first opening 440a is formed such that the center of the lower end surface thereof in the left-right direction is located at the rear focal point Fc of the projection lens 430. Therefore, the emission light from the projection lens 430 is emitted toward the front of the lamp as substantially parallel light slightly downward from the optical axis Ax2. Accordingly, the rendering light distribution pattern PBb is formed as a substantially rectangular light distribution pattern at a position substantially corresponding to a downward inclination angle of the projection lens 430.

Of the emission light from the light source unit 420, the light incident on the projection lens 430 via the first opening 440a is convergent light that is incident from the lower region 454L of the convex lens portion 454 of the condenser lens 450 and is emitted from the first lens portion 456A. Therefore, the rendering light distribution pattern PBa is formed in a long distance area of the road surface 2 in front of the lamp, but is formed as a light distribution pattern having sufficient sharpness and brightness.

The rendering light distribution pattern PBb formed in a short distance area is a light distribution pattern formed by emitting the emission light from the light source unit 420 toward the front of the lamp via the condenser lens 450, the second opening 440b of the light shielding plate 440, and the projection lens 430.

The rendering light distribution pattern PBb is formed as a reverse projection image of the second opening 440b having an inverted isosceles trapezoidal opening shape formed in the light shielding plate 440.

The second opening 440b is located at an uppermost position among the three openings, that is, the first opening 440a to the third opening 440c. Therefore, the rendering light distribution pattern PBb is formed in a short distance area of the road surface 2 in front of the lamp. Specifically, the second opening 440b has an opening shape larger than that of the first opening 440a. Therefore, the rendering light distribution pattern PBb is formed in a short distance area, but the rendering light distribution pattern PBb is formed as a substantially rectangular light distribution pattern having substantially the same size as the rendering light distribution pattern PBa.

Of the emission light from the light source unit 420, the light incident on the projection lens 430 via the second opening 440b is light that is incident on the condenser lens 450 from the upper region 454U of the convex lens portion 454 and is emitted from the second lens portion 456B. Therefore, the rendering light distribution pattern PBb is formed in a short distance area of the road surface 2 in front of the lamp, but is formed as a light distribution pattern having substantially the same sharpness and brightness as the rendering light distribution pattern PBa.

The rendering light distribution pattern PBc formed in a middle distance area is a light distribution pattern formed by emitting the emission light from the light source unit 420 toward the front of the lamp via the condenser lens 450, the third opening 440c of the light shielding plate 440, and the projection lens 430.

The rendering light distribution pattern PBc is formed as a reverse projection image of the third opening 440c having an inverted isosceles trapezoidal opening shape formed in the light shielding plate 440.

The third opening 440c is located between the first opening 440a and the second opening 440b. Therefore, the rendering light distribution pattern PBc is formed in a middle distance area of the road surface 2 in front of the lamp. Specifically, the third opening 440c has an opening shape larger than that of the first opening 440a and smaller than that of the second opening 440b. The rendering light distribution pattern PBc is formed in a middle distance area, but the rendering light distribution pattern PBc is formed as a substantially rectangular light distribution pattern having substantially the same size as the rendering light distribution patterns PBa and PBb.

Of the emission light from the light source unit 420, the light incident on the projection lens 430 via the third opening 440c is convergent light that is incident from the lower region 454L of the convex lens portion 454 of the condenser lens 450 and is emitted from the first lens portion 456A. The third opening 440c is located on the front side of the lamp with respect to the first opening 440a, and thus the brightness of the light incident on the projection lens 430 via the third opening 440c is reduced accordingly. Therefore, the rendering light distribution pattern PBc is formed in a middle distance area, but is formed as a light distribution pattern having substantially the same sharpness and brightness as the rendering light distribution pattern PBa formed in a long distance area.

Next, operations of the present embodiment will be described.

The rendering lamp 410 according to the present embodiment forms the rendering light distribution pattern PB by emitting the emission light from the light source unit 420 (that is, the emission light from the three light emitting elements 422) toward the front of the lamp via the light shielding plate 440 and the projection lens 430. The condenser lens 450 for condensing the emission light from the light source unit 420 toward the first opening 440a, the second opening 440b, and the third opening 440c of the light shielding plate 440 is disposed between the light source unit 420 and the light shielding plate 440. The projection lens 430 is disposed in a state of being inclined downward with respect to the front direction of the lamp. The light shielding plate 440 is disposed in a state of being inclined forward with respect to the condenser lens 450. Therefore, the following operations and effects can be obtained.

The projection lens 430 is disposed in a state of being inclined downward with respect to the front direction of the lamp. Therefore, the rendering lamp 410 may easily form the rendering light distribution pattern PB on the road surface 2 in front of the lamp. In addition, the light shielding plate 440 is disposed in a state of being inclined forward with respect to the condenser lens 450. Therefore, in the rendering lamp 410, the first opening 440a to the third opening 440c can be easily arranged in an appropriate direction with respect to the projection lens 430. Accordingly, the condenser lens 450 is disposed in a state of being directed to the front direction of the lamp, but the emission light from the light source unit 420 can be efficiently incident on the projection lens 430. Therefore, it is possible to provide the rendering lamp 410 that is easily mounted on the vehicle body or the like and can efficiently form the rendering light distribution pattern PB.

According to the present embodiment, in the rendering lamp 410 that forms the rendering light distribution pattern PB, it is possible to provide a rendering lamp that can be easily mounted on a vehicle body or the like and can efficiently form the rendering light distribution pattern PB.

In the rendering lamp 410 according to the present embodiment, the light shielding plate 440 is formed with the first opening 440a for long-distance rendering and the second opening 440b for short-distance rendering. The first opening 440a is formed at a position closer to the rear focal point Fc of the projection lens 430 than the second opening 440b. In the first opening 440a, the second opening 440b is formed at the position above the first opening 440a. Therefore, the following operations and effects can be obtained.

The first opening 440a is formed at the position close to the rear focal point Fc of the projection lens 430, and thus the rendering light distribution pattern PBa formed in a long distance area can be formed with substantially the same sharpness and brightness as the rendering light distribution pattern PBb formed in a short distance area. Accordingly, it is possible to enhance a reminder function to the surroundings by forming the rendering light distribution pattern PB.

In addition, in the rendering lamp 410 according to the present embodiment, the condenser lens 450 includes the plate-shaped portion 452 extending in the vertical direction, the convex lens portion 454 formed on the rear surface thereof, and the first lens portion 456A and the second lens portion 456B formed on the front surface of the plate-shaped portion 452. The first lens portion 456A emits the incident light from the lower region 454L of the convex lens portion 454 toward the first opening 440a. The second lens portion 456B emits the incident light from the upper region 454U of the convex lens portion 454 toward the second opening 440b. Therefore, the following operations and effects can be obtained.

After the emission light from the light source unit 420 is incident on the condenser lens 450 as light close to parallel light from the convex lens portion 454, the emission light is emitted from the first lens portion 456A, and is incident on the projection lens 430 via the first opening 440a. Therefore, the rendering lamp 410 may easily form the rendering light distribution pattern PBa in a long distance area. In addition, the emission light from second lens portion 456B is incident on the projection lens 430 via the second opening 440b. Therefore, the rendering lamp 410 may easily form the rendering light distribution pattern PBb in a short distance area.

The first lens portion 456A condenses the incident light from the lower region 454L of the convex lens portion 454 toward the first opening 440a. In addition, the second lens portion 456B deflects the incident light from the upper region 454U of the convex lens portion 454 downward. Therefore, the rendering lamp 410 can easily form the rendering light distribution patterns PBa and PBb in a long distance area and a short distance area as light distribution patterns each having appropriate sharpness and brightness. In addition, the second opening 440b is formed at the position above the first opening 440a formed at the position close to the rear focal point Fc of the projection lens 430, but the emission light from the light source unit 420 passing through the second opening 440b via the second lens portion 456B can be efficiently incident on the projection lens 430.

The rendering lamp 410 according to the present embodiment further includes the third opening 440c for middle-distance rendering formed between the first opening 440a and the second opening 440b as an opening configuration formed in the light shielding plate 440, the condenser lens 450 emits the incident light from the lower region 454L of the convex lens portion 454 from the first lens portion 456A toward the third opening 440c, and the curvature of the convex lens portion 454 in the vertical direction is set to a smaller value in the upper region 454U than in the lower region 454L, and thus the following operations and effects can be obtained.

That is, the lower region 454L of the convex lens portion 454 has a relatively large curvature in the vertical direction, and thus the light that is incident from the lower region 454L, emits from the first lens portion 456A, and then passes through the first opening 440a and the third opening 440c is incident on the projection lens 430, whereby it becomes possible to sufficiently ensure the sharpness and brightness of the rendering light distribution patterns PBa and PBc formed in a long distance area and a middle distance area, and it becomes easy to maintain the sharpness and brightness at substantially the same sharpness and brightness as the rendering light distribution pattern PBb formed in a short distance area.

In the second embodiment, the description has been given assuming that the light source unit 420 includes the three light emitting elements 422, but the light source unit 420 may include two or less light emitting elements 422 or four or more light emitting elements 422. In addition, the light emitting element 422 may not be incorporated in the light source unit 420.

In the second embodiment, the description has been given assuming that light-emitting colors of the three light emitting element 422 are white, but other light-emitting colors (for example, blue or green) may be adopted.

In the second embodiment, the description has been given assuming that the rendering light distribution pattern PB is formed on the road surface 2 in front of the lamp by the emission light from the rendering lamp 410, but the rendering lamp 410 may form the rendering light distribution pattern on a wall surface disposed in front of the lamp, a wall surface extending toward the front of the lamp, or the like.

Next, a fourth modification, which is a modification of the second embodiment, will be described.

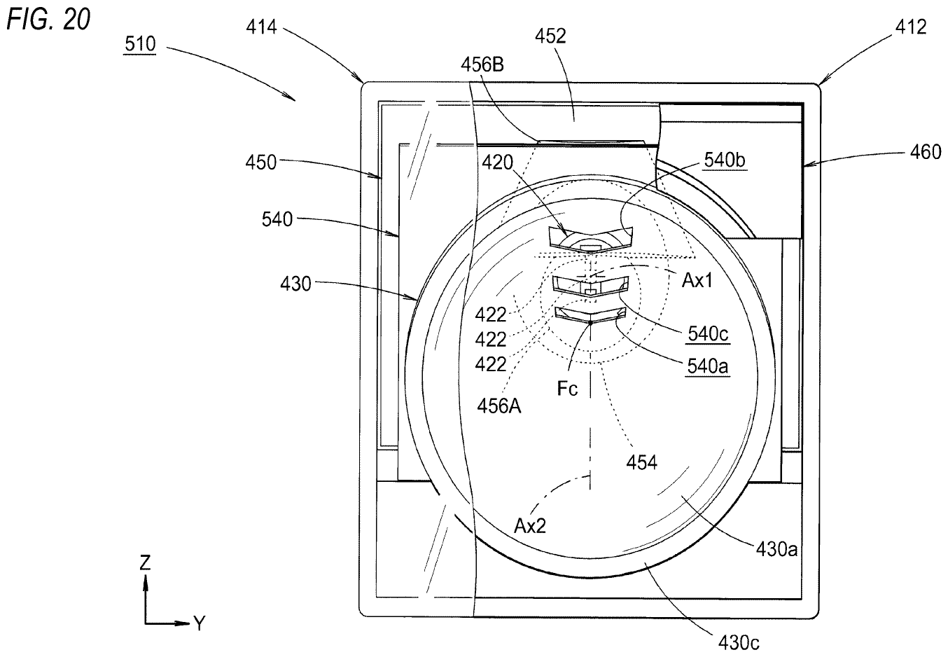

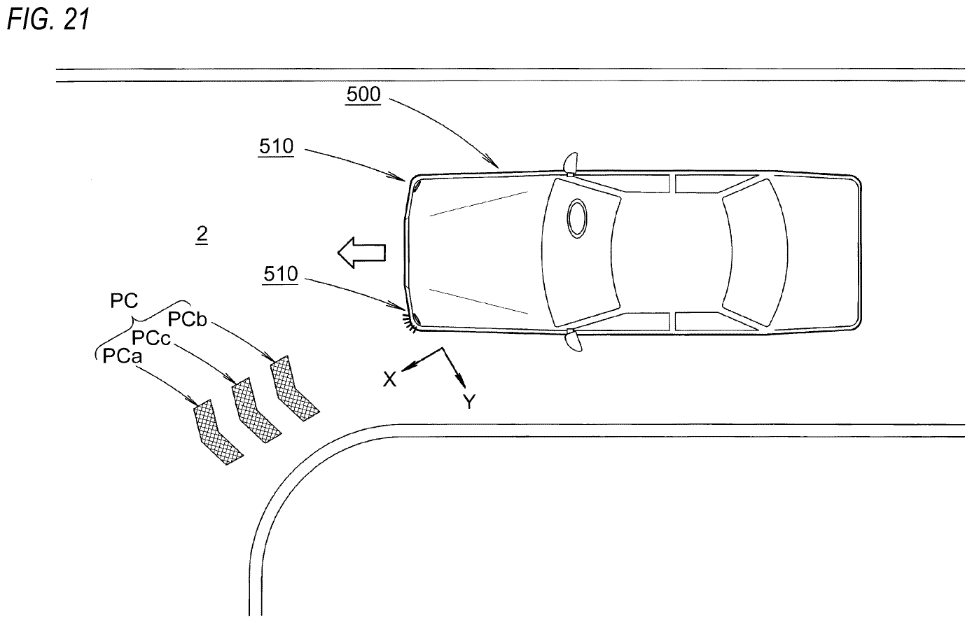

FIG. 20 is a front view illustrating a rendering lamp 510 according to the fourth modification. FIG. 20 is a view from the same direction as in FIG. 12. In addition, FIG. 21 is a plan view illustrating a state in which the rendering lamp 510 are mounted on the vehicle 500. FIG. 21 is a view from the same direction as in FIG. 19.

As illustrated in FIG. 21, the rendering lamp 510 according to the present modification emit light obliquely downward toward the oblique front of the vehicle in a state of being mounted at two positions of both left and right end portions of front end portions of the vehicle 500. The pair of left and right rendering lamp 510 have the same configuration. The pair of left and right rendering lamp 510 are turned on in synchronization with turning on of front turn signal lamps (not illustrated). FIG. 21 illustrates a state in which the left rendering lamp 510 is turned on.

Each of the pair of left and right rendering lamp 510 forms a rendering light distribution pattern PC including three rendering light distribution patterns PCa, PCb, and PCc on the road surface 2 in front of the lamp (that is, a road surface in oblique front of the vehicle) by the emission light.

As illustrated in FIG. 20, a basic configuration of the rendering lamp 510 is similar to that of the rendering lamp 10 according to the second embodiment, but a configuration of a light shielding plate 540 is partially different from that of the second embodiment.

The light shielding plate 540 of the fourth modification also has the same external shape as the light shielding plate 440 of the second embodiment. The light shielding plate 540 is disposed at the same inclination angle as the light shielding plate 440 of the second embodiment. In addition, the light shielding plate 540 of the present modification is formed with a first opening 540a for long-distance rendering, a second opening 540b for short-distance rendering, and a third opening 540c for middle-distance rendering. The first opening 540a, the second opening 540b, and the third opening 540c are formed at substantially the same positions as the first opening 440a, the second opening 440b, and the third opening 440c of the second embodiment. The present modification is different from the second embodiment in that the first opening 540a, the second opening 540b, and the third opening 540c are each formed into a V-shaped opening shape.

The second opening 540b has an opening shape larger than that of the first opening 540a. The second opening 540b is formed such that both side end surfaces thereof are located on extension lines of both side end surfaces of the first opening 540a. In addition, the third opening 540c has an opening shape larger than that of the first opening 540a but smaller than that of the second opening 540b. The third opening 540c is formed such that both side end surfaces thereof are located on the extension lines of both side end surfaces of the first opening 540a.

As illustrated in FIG. 21, the three rendering light distribution patterns PCa, PCb, and PCc constituting the rendering light distribution pattern PC are inverted V-shaped light distribution patterns obtained by inverting the opening shapes of the first opening 540a, the second opening 540b, and the third opening 540c. The three rendering light distribution patterns PCa, PCb, and PCc are formed in a long distance area, a short distance area, and a middle distance area of the road surface in front of the lamp (that is, the road surface in oblique front of the vehicle) 2 at substantially the same size and at substantially equal intervals in the series arrangement.

In the rendering lamp 510 according to the present modification, the projection lens 430 is also disposed in a state of being inclined downward with respect to the front direction of the lamp, and thus the rendering light distribution pattern PC can be easily formed on the road surface 2 in front of the lamp. In addition, the light shielding plate 540 is disposed in a state of being inclined forward with respect to the condenser lens 450, and thus it is possible to easily dispose the first opening 540a, the second opening 540b, and the third opening 540c in an appropriate direction with respect to the projection lens 430. Accordingly, the condenser lens 450 is disposed in a state of being directed to the front direction of the lamp, but the emission light from the light source unit 420 can be efficiently incident on the projection lens 430. Therefore, the rendering lamp 510 can be easily mounted on the vehicle body or the like, and can efficiently form the rendering light distribution pattern PC.

Numerical values shown as specifications in the first embodiment, the second embodiment, and the first modification to the fourth modification are merely examples, and as a matter of course, these numerical values may be set to different values as appropriate.

In addition, the present disclosure is not limited to the configurations described in the first embodiment, the second embodiment, and the first modification to the fourth modification, and a configuration added with various other changes may be adopted.

The “rendering lamp” may be an in-vehicle lamp or a lamp used for a purpose other than the in-vehicle lamp.

The “projection lens” is not particularly limited in terms of specific shape thereof, specific inclination angle thereof, and the like, as long as the optical axis is disposed in a state of being inclined downward toward the front direction of the lamp.

The “light shielding plate” of the first embodiment is not particularly limited in terms of specific arrangement thereof, as long as the “light shielding plate” shields a part of the light traveling from the light emitting element to the projection lens between the light emitting element and the projection lens. In addition, the “light shielding plate” of the second embodiment is not particularly limited in terms of specific arrangement thereof or specific inclination angle thereof, as long as the “light shielding plate” is disposed in a state of being inclined forward with respect to the condenser lens.

The “opening” is not particularly limited in terms of specific opening shape thereof, as long as the “opening” can cause the emission light from the light emitting element to be incident on the projection lens.

The “plate-shaped portion” is not particularly limited in terms of specific shape thereof, as long as the “plate-shaped portion” extends in the direction inclined downward with respect to the front direction of the lamp in the upper region of the outer peripheral edge portion of the projection lens.

Contents disclosed in a Japanese patent application (JP2023-073057) filed on Apr. 27, 2023 and a Japanese patent application (JP2023-076924) filed on May 8, 2023 are appropriately incorporated in the present application.

1. A rendering lamp configured to form a rendering light distribution pattern by emitting emission light from a light emitting element toward a front of the rendering lamp via a projection lens,
wherein a light shielding plate configured to shield a part of the light traveling from the light emitting element toward the projection lens is disposed between the light emitting element and the projection lens,
wherein the light shielding plate is formed with an opening for causing the emission light from the light emitting element to be incident on the projection lens,
wherein the projection lens is disposed in a state of being inclined downward with respect to a front direction of the lamp, and
wherein a plate-shaped portion is formed in an upper region of an outer peripheral edge portion of the projection lens, the plate-shaped portion extending in a direction inclined downward with respect to the front direction of the lamp.

2. The rendering lamp according to claim 1, wherein a plate-shaped extension portion extending upward is formed at a front end portion of the plate-shaped portion.

3. The rendering lamp according to claim 1, wherein a surface of the plate-shaped portion is subjected to a light diffusion treatment.

4. The rendering lamp according to claim 1,
wherein an annular flange portion is formed on the outer peripheral edge portion of the projection lens, and
wherein the plate-shaped portion extends in a circumferential direction along the annular flange portion.

5. The rendering lamp according to claim 1, wherein the light shielding plate is disposed in a state of being inclined forward with respect to a vertical plane.

6. A rendering lamp configured to form a rendering light distribution pattern by emitting emission light from a light emitting element toward a front of the rendering lamp via a projection lens,
wherein a light shielding plate configured to shield a part of the light traveling from the light emitting element toward the projection lens is disposed between the light emitting element and the projection lens,
wherein the light shielding plate is formed with an opening for causing the emission light from the light emitting element to be incident on the projection lens,
wherein a condenser lens configured to condense the emission light from the light emitting element toward the opening is disposed between the light emitting element and the light shielding plate,
wherein the projection lens is disposed in a state of being inclined downward with respect to a front direction of the lamp, and
wherein the light shielding plate is disposed in a state of being inclined forward with respect to the condenser lens.

7. The rendering lamp according to claim 6,
wherein the light shielding plate includes a first opening for long-distance rendering and a second opening for short-distance rendering as openings,
wherein the first opening is formed at a position closer to a rear focal point of the projection lens than the second opening, and
wherein the second opening is formed at a position above the first opening.

8. The rendering lamp according to claim 7,
wherein the condenser lens includes a plate-shaped portion extending in a vertical direction, a convex lens portion formed on a rear surface of the plate-shaped portion, and a first lens portion and a second lens portion formed on a front surface of the plate-shaped portion,
wherein the first lens portion emits incident light from a lower region of the convex lens portion toward the first opening, and
wherein the second lens portion emits incident light from an upper region of the convex lens portion toward the second opening.

9. The rendering lamp according to claim 8,
wherein the first lens portion condenses the incident light from the lower region of the convex lens portion, and
wherein the second lens portion deflects the incident light from the upper region of the convex lens portion downward.

10. The rendering lamp according to claim 8,
wherein the light shielding plate includes a third opening for middle-distance rendering formed between the first opening and the second opening as the opening,
wherein the condenser lens emits the incident light from the lower region of the convex lens portion from the first lens portion toward the third opening, and
wherein a curvature of the convex lens portion in the vertical direction is set to a smaller value in the upper region than in the lower region.
